(19) United States
(12) Patent Application Publication
(10) Pub. No.: US 2026/0179792 A1
(43) Pub. Date: Jun. 25, 2026

(54) Fusion System includes a First Shell that includes a First Portion of a Toroidal Interior Chamber, a Second Shell includes a Second Portion of the Toroidal Interior Chamber, wherein the Toroidal Interior Chamber includes an Interior Surface having Rifling, a Conductive Center Piece is a Ring between the Inside Perimeter of the First Shell and the Inside Perimeter of the Second Shell, putting the First Shell in Electrical Contact with the Second Shell

(71) Applicant: Kepler Fusion Technologies Inc., Southlake, TX (US)

(72) Inventors: John Brandenburg, Jacksonville, OR (US); Michael G. Smith, Keller, TX (US)

(21) Appl. No.: 19/538,670

(22) Filed: Feb. 12, 2026

Related U.S. Application Data
(63) Continuation of application No. 18/354,637, filed on Jul. 18, 2023.
Application No. 18/354,637 is a continuation-in-part of application No. 17/826,274, filed on May 27, 2022, now abandoned.
Application No. 17/826,274 is a continuation of application No. 17/736,084, filed on May 3, 2022, now abandoned.
Application No. 18/354,637 is a continuation-in-part of application No. 17/736,084, filed on May 3, 2022, now abandoned.

(51) Int. Cl. G21B 1/17; G21B 1/05; G21B 1/15; G21B 1/21

(52) U.S. Cl. CPC G21B 1/17; G21B 1/055; G21B 1/15; G21B 1/21

(57) ABSTRACT

Systems, methods and apparatus are provided through which in some implementations an experimental fusion system includes a first shell that includes a first portion of a toroidal interior chamber, a second shell includes a second portion of the toroidal interior chamber, wherein the toroidal interior chamber includes an interior surface having rifling, a conductive center piece is a ring and is positioned between the inside perimeter of the first shell and the inside perimeter of the second shell, putting the first shell in electrical contact with the second shell.

### RELATED APPLICATIONS

This application is a continuation patent application claiming priority under 35 U.S.C. 120 of pending U.S. Ser. No. 18/354,637 filed on 18 Jul. 2023 having docket Kep.u.0002.C-001 which is a continuation-in-part patent application claiming priority under 35 U.S.C. 120 of U.S. Ser. No. 17/736,084 filed on 3 May 2022 and abandoned on 10 Oct. 2023 having docket Kep.u.0002.

This application is a continuation patent application claiming priority under 35 U.S.C. 120 of pending U.S. Ser. No. 18/354,637 filed on 18 Jul. 2023 having docket Kep.u.0002.C-001 which is a continuation-in-part patent application claiming priority under 35 U.S.C. 120 of U.S. Ser. No. 17/826,274 filed on 27 May 2022 and abandoned on 3 Oct. 2023 having docket Kep.u.0002.Cont-01, which is a continuation patent application claiming priority under 35 U.S.C. 120 of U.S. Ser. No. 17/736,084 filed on 3 May 2022 and abandoned on 10 Oct. 2023 having docket Kep.u.0002.

### FIELD

This disclosure relates generally to experimental fusion nuclear reactors, and more particularly to experimental toroidal nuclear reactors.

### BACKGROUND

Nuclear fusion is a reaction in which two or more atomic nuclei are combined to form one or more different atomic nuclei and subatomic particles (neutrons or protons). The difference in mass between the reactants and products is manifested as either the release difference in atomic binding energy between the nuclei before and after the reaction.

A stellarator is a toroidal nuclear reactor for producing controlled nuclear fusion that involves the confining and heating of a gaseous plasma by means of an externally applied magnetic field.

A torsatron is a stellarator with continuous helical coils, or with a number of discrete coils that produce a similar field.

Shock heating of plasmas for fusion was demonstrated early in the fusion effort but was largely abandoned in favor of the steady state tokamak and stellarator approaches which demonstrated superior plasma confinement. Shock heating of plasmas to fusion temperatures was successfully demonstrated at Los Alamos in the Scylla and Scyllac devices in the early 60's. The tokamak and stellarator nuclear fusion reactors include a separate auxiliary heating method to bring the plasma to fusion temperatures. The heating apparatus adds considerably to the complexity and mass of any fusion device.

Many efforts have been, and presently are, focused on harnessing fusion energy using toroidal magnetic confinement of plasmas, such as in the tokamak or stellarator in steady state. The tokamak is a device which uses a powerful magnetic field to confine plasma in the shape of a torus. The stellarator is a plasma device that relies primarily on external magnets to confine a plasma. In the tokamak, the rotational transform of a helical magnetic field is formed by a toroidal field generated by external coils together with a poloidal field generated by the plasma current. In the stellarator, the twisting field is produced entirely by external non-axisymmetric coils.

Shock heating of plasmas to fusion temperatures with subsequent MHD (Magneto-Hydro-Dynamic) stable confinement was demonstrated at Los Alamos in the Scylla and Scyllac devices, as disclosed in K. F. McKenna and R. E. Siemon, “Theta-pinch research at Los Alamos” Nuclear Fusion 25(9):1267 (2011) and R. E. Siemon “A Summary of Scylla Results” LANL Informal report LA-7125-MS (1978). The Scylla machine, a straight Theta Pinch, was successful in demonstrating shock-heating of plasma to fusion temperatures but was open at both ends, allowing the plasma to escape. A torsatron magnetic configuration has been demonstrated to confine plasmas in steady state, such as disclosed in J. Lyon et al. “Compact Torsatron Reactors”, ORNL/TM-10572, 1988 and S. P. Bondarenko et. al, “First Experimental Results of URAGAN 3M Torsatron,” Plasma Physics and Controlled Fusion Research 1990, Proc. 13th International Conf. on Plasma Physics and Controlled Fusion Research Vol. 2.). Z-pinch devices typically pulse the plasma for 20 to 100 microseconds, up to 10 pulses per second.

Tokomaks and stellarators are steady state machines, which are not pulsed. The technical focus on steady state systems has taught away from consideration of rapid timescale effects.

### BRIEF DESCRIPTION

The above-mentioned shortcomings, disadvantages and problems are addressed herein, which will be understood by reading and studying the following specification.

In one aspect, an experimental fusion system includes a rifled toroidal pinch torsatron that is operable to attain nuclear fusion of about an equal amount of helium3 and deuterium.

In another aspect, an experimental fusion system includes a rifled toroidal pinch torsatron that is operable to attain nuclear fusion of about an equal amount of helium3 and deuterium through pulsing fusion.

In yet another aspect, an experimental fusion system includes a rifled toroidal pinch torsatron with 5-6 set of ridges and grooves.

Apparatus, systems, and methods of varying scope are described herein. In addition to the aspects and advantages described in this summary, further aspects and advantages will become apparent by reference to the drawings and by reading the detailed description that follows.

### BRIEF DESCRIPTION OF THE DRAWINGS

FIG. 1 is a cross section block diagram of an overview of an experimental fusion system to manage fusion reactions, according to an implementation.

FIG. 2 is a cross section block diagram of a wire-coil torsatron experimental fusion system, according to an implementation.

FIG. 3 is block diagram of a fusion control system, according to an implementation.

FIG. 4 is an isometric cross section block diagram of a three-coil torsatron operable in the fusion confinement device in FIG. 2, according to an implementation.

FIG. 5 is an isometric cross section block diagram of a six-coil stellarator operable in the fusion confinement device in FIG. 2, according to an implementation.

FIG. 6 is an isometric cross section block diagram of a heliotron operable in the fusion confinement device in FIG. 2, according to an implementation.

FIG. 7 is an isometric cross section block diagram of a partly de-energized heliotron operable in the fusion confinement device in FIG. 2, according to an implementation.

FIG. 8 is an isometric diagram of a half-shell of a six-coil torsatron operable in the fusion confinement device in FIG. 1, according to an implementation.

FIG. 9-13 are isometric diagrams of a six-coil torsatron operable in the fusion confinement device in FIG. 1, according to an implementation.

FIG. 14 is an isometric diagram of a six-lead exterior current feed configuration of a fusion confinement device in FIG. 1-3, according to an implementation.

FIG. 15 is a flowchart of a method to control an experimental fusion system, according to an implementation.

FIG. 17 is a block diagram of an experimental fusion system control computer, according to an implementation.

FIG. 18 is a block diagram of a data acquisition circuit of an experimental fusion system control computer in FIG. 17, according to an implementation.

FIG. 19 is a block diagram of a fusion reactor control mobile device, according to an implementation.

### DETAILED DESCRIPTION

In the following detailed description, reference is made to the accompanying drawings that form a part hereof, and in which is shown by way of illustration specific implementations which may be practiced. These implementations are described in sufficient detail to enable those skilled in the art to practice the implementations, and it is to be understood that other implementations may be utilized and that logical, mechanical, electrical and other changes may be made without departing from the scope of the implementations. The following detailed description is, therefore, not to be taken in a limiting sense.

The detailed description is divided into five sections. In the first section, apparatus of implementations are described. In the second section, implementations of methods are described. In the third section, a hardware and the operating environment in conjunction with which implementations may be practiced are described. Finally, in the fourth section, a conclusion of the detailed description is provided.

This disclosure can be utilized for many types of uses, including experimental use.

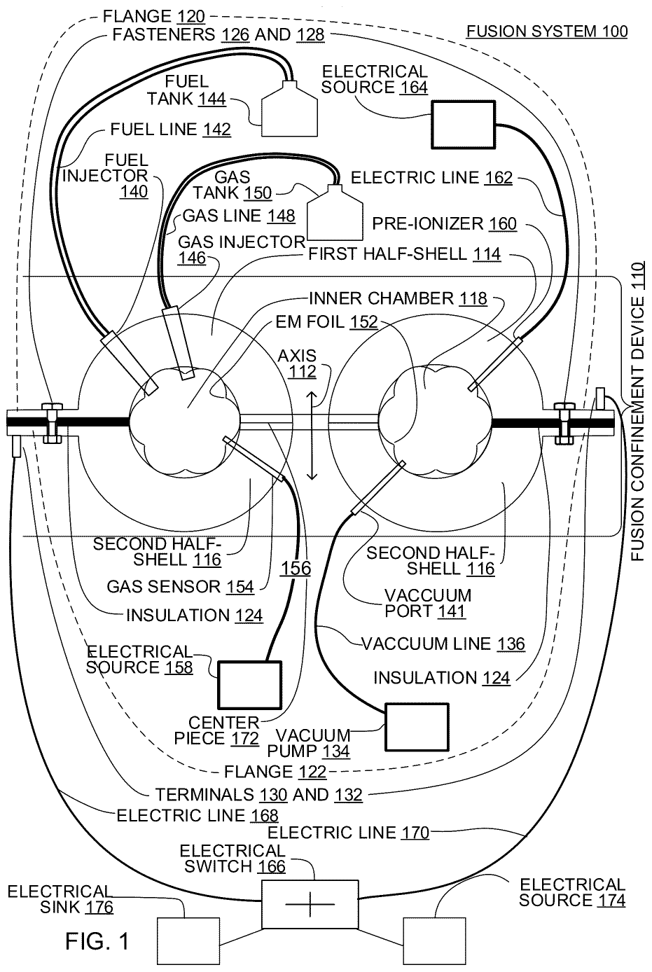

FIG. 1 is a block diagram of an overview of an experimental fusion system 100 to manage fusion reactions, according to an implementation. In this section, particular apparatus of implementations are described by reference to a series of diagrams.

In fusion system 100, a torsatron magnetic configuration is employed to maintain a hot-dense plasma in a toroidal equilibrium configuration during the fusion power pulse.

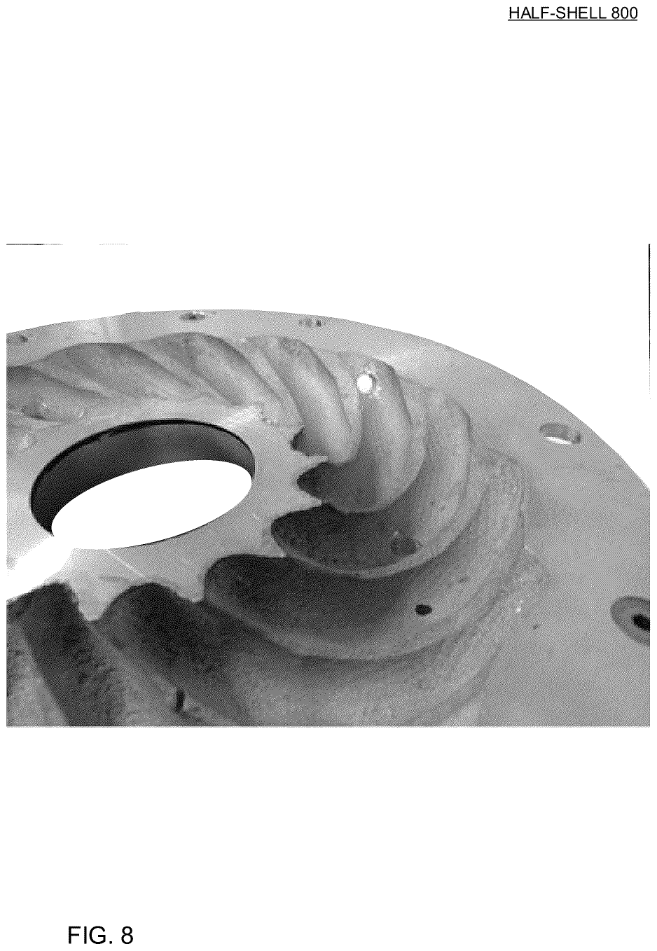

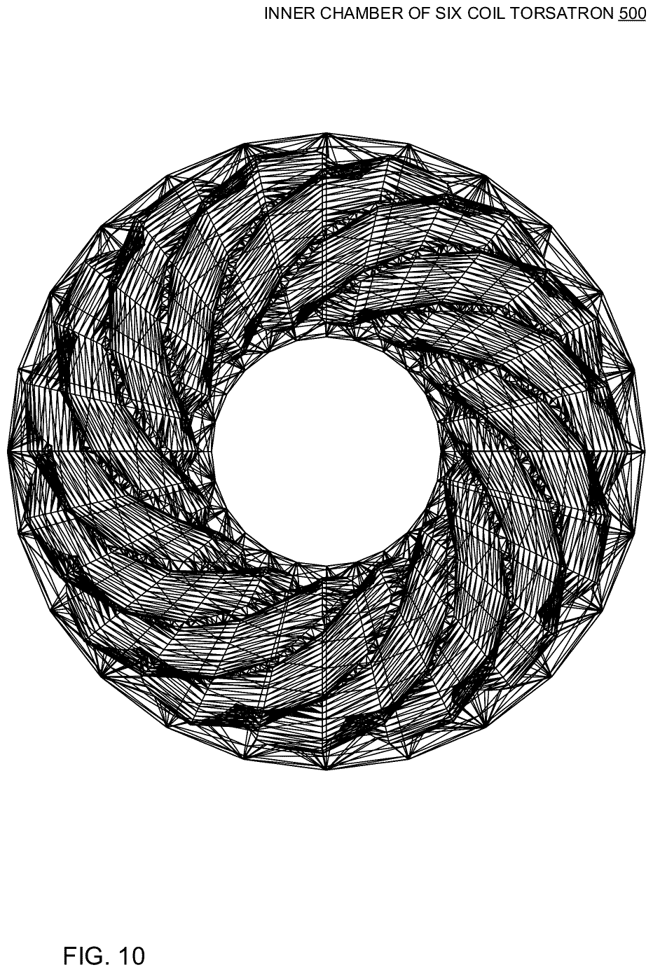

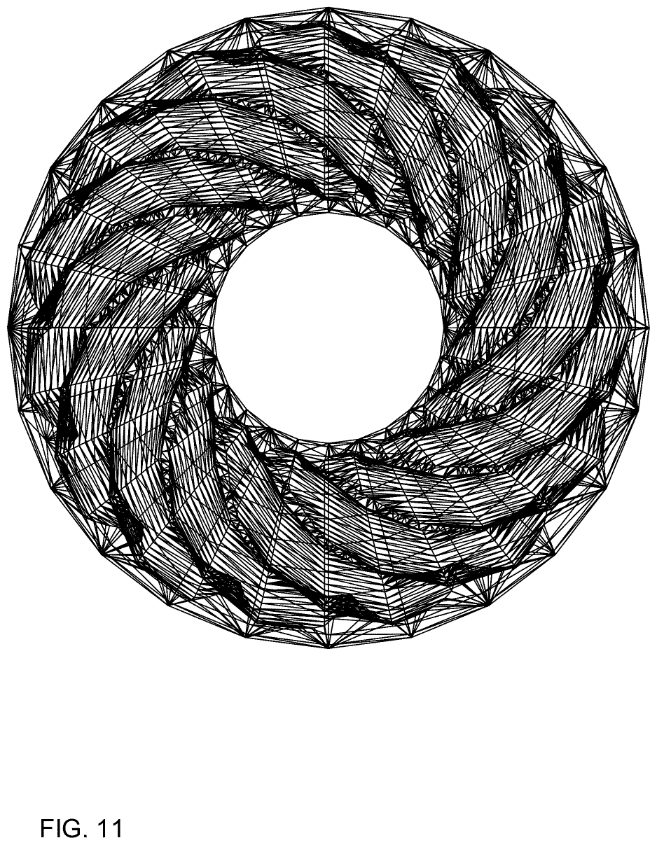

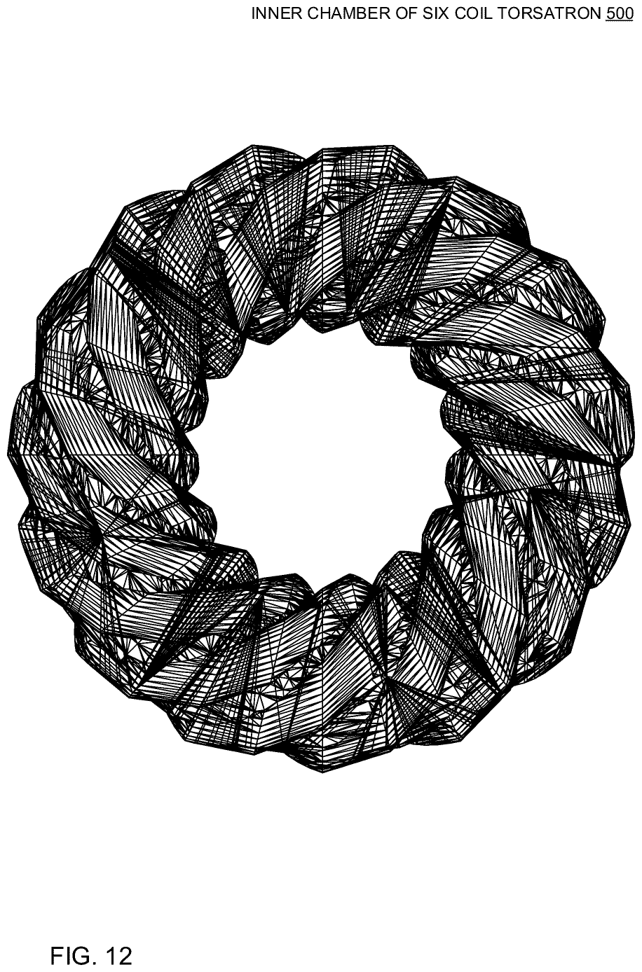

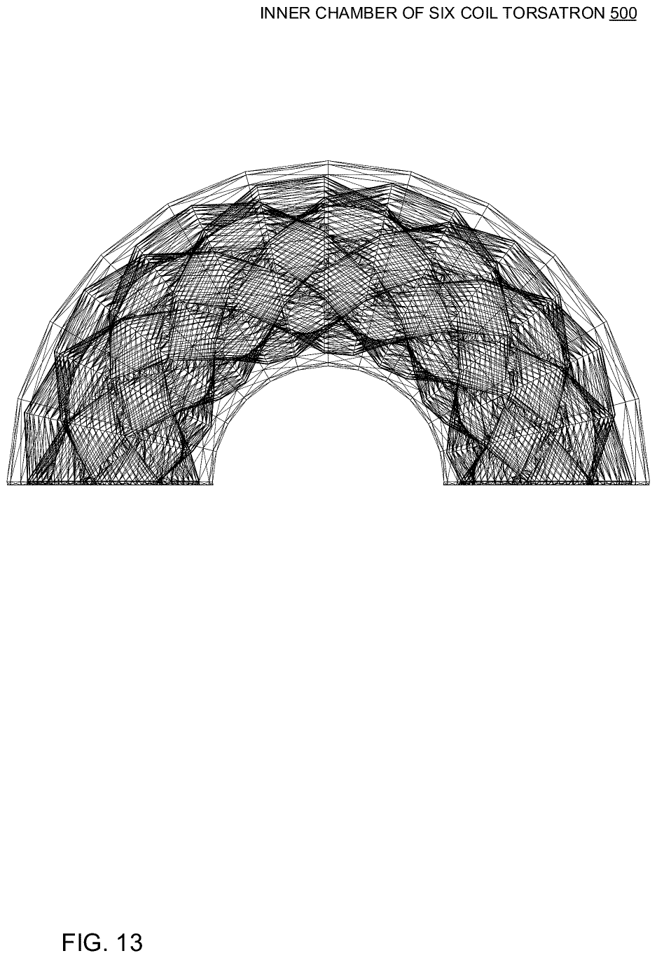

The fusion system 100 includes a fusion confinement device 110 (and a center axis 112 of the fusion confinement device 110) enclosing a first half-shell 114 and a second half-shell 116. In some implementations such as shown in FIG. 1, the first half-shell 114 is symmetrical to the second half-shell 116. The first half-shell 114 and the second half-shell 116 form an inner chamber 118. The inner chamber 118 forms a rifled toroidal theta pinch (RTTP), as shown in FIG. 8-13. The inner chamber 118 is also referred to as a hollow toroidal interior chamber.

A cross section diagram of the fusion confinement device 110 is shown in FIG. 1. The fusion confinement device 110 is circular in shape when viewed from above. In some implementations the inner chamber 118 is circular in shape in cross-section (as shown in FIG. 1). In other embodiments the inner chamber 118 has a square shape in cross-section, and in other implementations the inner chamber 118 has a parabolic shape in cross-section. In other implementations of the fusion confinement device 110, the two halves (the first half-shell 114 and the second half-shell 116) are unequal and asymmetrical portions of the inner chamber 118. For example, one portion of the inner chamber 118 forms 90 degrees of the inner chamber 118 and the other portion of the inner chamber 118 forms 270 degrees of cross section of the inner chamber 118. In some implementations, the diameter of the inner chamber 118 torus is 3 meters. In some implementations, the diameter of the inner chamber 118 torus is 1 meter.

In the fusion confinement device 110, both the second half-shell 116 and the first half-shell 114 include a flange 120 and 122, respectively, on the outer perimeters. Electrical insulation 124 is in between the flanges 120 and 122. The second half-shell 116 and the first half-shell 114 are held together by non-ferrous and non-conductive fasteners 126 and 128 thereby holding together the first half-shell 114 and the second half-shell 116. The flanges 120 and 122 also include electrical terminals 130 and 132. Terminals 130 and 132 are connected to flange 122, and in some implementations penetrate the flange 122 but in no case do the terminals 130 and 132 penetrate the insulation layer 124. Each of the non-ferrous and non-conductive fasteners 126 and 128 can include the nut-and-bolt implementation of the non-ferrous and non-conductive fasteners 126 and 128 as shown in FIG. 1, but can include any other functionally equivalent apparatus to hold together the second half-shell 116 and the first half-shell 114, such as C-clamps.

The fusion system 100 further includes a vacuum pump 134 that is operably coupled to a vacuum line 136, that is operably coupled to a vacuum port 138 in the wall of the second half-shell 116.

The fusion confinement device 110 of the fusion system 100 further includes a fuel injector 140 that traverses through the hemispherical portion of the first half-shell 114 and into the inner chamber 118. The fuel injector 140 receives a fuel through a fuel line 142 that receives the fuel from fuel tank(s) 144. Examples of the fuel include a 50/50 mix of gaseous helium3 and gaseous deuterium, in which case, the fuel tank(s) 144 includes two fuel tanks, a first tank for the gaseous helium3 and a second tank for the gaseous deuterium. In some implementations, the fuel tank(s) include a third tank to store gaseous tritium for the fuel.

In some implementations, a gas injector 146 in the fusion confinement device 110 of the fusion system 100 is coupled to, and receives gas from a gas line 148 outside of the fusion confinement device 110 that is coupled to a gas tank 150. The gas injector 146 injects the concentration(s) of gases into the inner chamber 118, such as the concentration of tritium and/or helium4. When helium4 is injected into the inner chamber 118 by the gas injector 146 and helium3 is also injected into the inner chamber 118 by the fuel injector 140, the helium4 will not fuse with the helium3 because helium4 is inert and is not reactive in fusion.

In some implementations, the inner chamber 118 includes at least one electromagnetic (EM) foil 152 (such as 5-6 EM foils) that are evenly spaced away from each other.

When injected, the fuel is pressurized and heated to fusion by the pressure and temperatures of a plasma that are created by the EM foil(s) 152 that traverse(s) the torodial inner chamber 118. The EM foil 152 is not a spiraled wire that is mounted or attached to a ridge of the inner chamber 118. Rather the ridge acts as an EM foil 152 when electricity passes through the inner chamber 118 and the electricity aggregates and concentrates along the ridge as indicated by Maxwell's Equations to the extent that nearly all of the electricity is in the ridge. The EM foil 152 shapes electromagnetic force and generates maximum compression force in the same way that a hydrofoil shapes water to generate a maximum lifting force. The EM foil 152 also shapes the electromagnetic field to produce a configuration that maximizes stability on the plasma.

Maxwell's equations indicate that for pulsed fields, the magnetic lines of force must lie in the metal grooves, and be parallel everywhere to the metal surfaces, and also not penetrate the metal surfaces. The electric current in the metal surface must follow this pattern and be consistent with the magnetic field. This follows from Faraday's law and the law that forbids magnetic monopoles (Maxwell's equations #2 and #3). Maxwell's equation #3 indicates that a magnetic field (B or H) does not flow outward or inward (because the right-hand side is zero). Maxwell's equation #2 is derived from Faraday's laws of Electromagnetic Induction, which indicates that whenever there are n-turns of conducting coil in a closed path which is placed in a time-varying magnetic field, an alternating electromotive force gets induced in each and every coil, which is given by Lenz's law. Faraday's law indicates that the time rate of change of the magnetic field is proportional to the vorticity of the electric field around the magnetic lines of force, meaning that since the electric field vanishes for pulsed fields inside the metal, the magnetic lines of force that penetrate the metal surface must end inside it. But his would mean magnetic monopoles (magnetic free charge) would have to exist in the metal, but since magnetic fields have no monopoles like electric fields, the pulsed magnetic lines of force cannot penetrate the metal surfaces but must lie parallel to those surfaces.

In regards to the geometric shape of the surface of the inner chamber 118, in some implementations, the ratio of the distance from the center of the cross-section of the inner chamber 118 to the grooves in comparison to the distance from the center of the cross-section of the inner chamber 118 to the ridges is 1.16.

The rifling of the first half-shell 114 and the second half-shell 116 that form the inner chamber 118 for this pulsed system causes “burning in” a flux invariant A.B (the Taylor invariant, where A is the magnetic vector potential) into the plasma, which then persists to create helical magnetic fields in the plasma and the inner chamber 118, even though the immediate effect of the rifling fades with time. The plasma will relax into a minimum energy state (Taylor relaxation) while preserving the global average value of A.B and other flux invariants). Such complex interactions between the plasma and rifling on the walls of the chamber over time are seemingly counter intuitive. In the implementation shown in FIG. 1, the grooves have a semi-circular geometric shape. In other implementations, the grooves have a hemispherical-circular geometric shape. In other implementations, the grooves have a square (right-angled) geometric shape. In other implementations, the grooves have a parabolic geometric shape.

A gas sensor 154 in the fusion confinement device 110 of the fusion system 100 is electrically powered by, and coupled to, an electric line 156 outside of the fusion confinement device 110 that is electrically coupled to an electrical source 158. The gas sensor 154 determines the concentration(s) of gases in inner chamber 118, such as the concentration of tritium or helium4.

The fuel in the fusion system 100 is a mixture of gaseous helium3 and gaseous deuterium. In some implementations, the mixture of gaseous helium3 and gaseous deuterium is a mixture of about 50% gaseous helium3 and about 50% gaseous deuterium in which molecules of the gaseous helium3 fuses with molecules of the gaseous deuterium in the inner chamber 118. In some implementations, a small amount of tritium is added to aid ignition of the fusion reaction.

A pre-ionizer 160 in the fusion confinement device 110 is electrically energized by, and coupled to, an electric line 162 outside of the fusion confinement device 110 that is electrically coupled to an electrical source 164.

In some implementations, an electrical switch 166 is operable to open a circuit (through electric line 170) between an electrical source 174 and the second half-shell 116. In some implementations, the electrical source 174 includes a voltage capacitor bank having 500 miliFarads and 14 million Joules of energy that provides 15,000 volts. In some implementations, the electrical source 174 includes a voltage capacitor bank having 500 miliFarads and 1 million Joules of energy that provides 15,000 volts.

In some implementations, output power from the fusion confinement device 110 along the electric line 170 is controlled by solid state switching in the electrical switch 166. In some implementations, the electrical source 174 provides a million Joules of energy at 15,000 volts. In alternative embodiments, the electrical source 174 is electrically connected to second half-shell 116 rather than the first half-shell 114 and the electrical sink 176 is connected to the first half-shell 114 rather than the second half-shell 116.

In some implementations, regenerative energy recovery is performed by the electrical switch 166 by diverting some of the electricity that is transferred from the second half-shell 116 to the electrical sink 176 instead to the electrical source 174, in order to replace the electricity that is transferred from the electrical source 174 to the second half-shell 116. The regenerative energy recovery occurs because the fusion energy pulse heats the plasma confined by the magnetic field and expands against the plasma, creating a current in EM foil 152, which using the electrical switch 166, can be used to recharge the electrical source 174.

In the implementation of a conductive center piece 172 shown in FIG. 1, the conductive center piece 172 is a round disk. In other implementations, the conductive center piece 172 is a ring that is only between the first half-shell 114 and the second half-shell 116, but is absent between the hemispheres of the first half-shell 114 and the second half-shell 116.

The electrical switch 166 is operable to open a circuit (through electric lines 168 and 170) between an electrical sink 176 and the second half-shell 116. The electricity from the electrical source 174 flows into the flange 120 of the first half-shell 114 through the terminal 130 and then around the rifled inner chamber 118 into the center piece 172 then around the second half-shell 116 before exiting the terminal 132 back to the electrical source 174. In some implementations, the first half-shell 114 will be charged negative and the second half-shell 116 will be charged positive, but in other implementations, that polarity will be reversed. Examples of the electrical sink 176 are a battery or a power conditioner.

The present systems, method and apparatus do not include a separate auxiliary heating device to bring the plasma to fusion temperatures, in contrast to the tokamak and stellarator devices that do include a separate auxiliary heating method to bring the plasma to fusion temperatures. The absence of an auxiliary heating device significantly reduces the complexity and mass of the apparatus 100, which is especially helpful in achieving deuterium-helium3 fusion reaction, however, the deuterium and helium3 fusion requires hotter and denser plasmas than the deuterium-tritium) fusion reaction and is thus more technically challenging. Nonetheless, the aneutronic fusion reaction excludes and obviates the need for a steam turbine to generate electricity.

Aneutronic fusion is any form of fusion reaction in which very little of the energy released is carried by neutrons. While the lowest-threshold nuclear fusion reactions release up to 80% of their energy in the form of neutrons, aneutronic reactions release energy in the form of charged particles, typically protons or alpha particles. Successful aneutronic fusion greatly reduces problems associated with neutron radiation such as damaging ionizing radiation, neutron activation, and requirements for biological shielding, remote handling and safety.

Aneutronic fusion reaction eliminates the radiation from neutrons, which are difficult to shield against, and usually is implemented by heavy and costly shielding.

In the systems, methods and apparatus described herein however, the same toroidal magnetic configuration, called a torsatron, which is used to confine the fusion plasma, is used to initially shock heat the plasma to fusion temperatures. However, drawing on the inherent simplicity of the well demonstrated torsatron configuration and its unexploited ability to achieve shock heating of plasmas.

The magnetic field, pulse time and gas density required to heat a deuterium and helium3 mixture to the required density and 30 to 60 KeV (600 million degrees K) temperatures, assuming a pulse length of 100 milliseconds are determined as follows: When a thin pre-ionized plasma is present in the inner chamber 118 and a fast-rising magnetic field pulse is applied at the walls, the plasma is then swept up in a “snowplow” shockwave of approximate speed Vₛ=(B²/8π ρ)¹/² CGS. The plasma layer implodes and stagnates on itself converting its kinetic energy to heat. The resulting plasma pressure is approximately equal to the peak magnetic energy density of the pulse: B²/8π. Assuming a pulse length of 1 millisecond, the fusion triple product condition ntT for deuterium and helium3 is an energy density of 1.6×10⁴ atmospheres, corresponding to an approximate pulsed magnetic field strength of 200 kG or 20T.

Modifications to these numbers can occur due to MHD (Magneto-Hydro-Dynamic) stability requirements of the confined plasma that may lessen the ratio of thermodynamic energy in the plasma divided by the magnetic energy density, a ratio called Q. A being R 100% for a system is considered optimal, however MHD plasma requirements may lower R to the lesser value of 4%. This can be compensated for by raising the magnetic field or lengthening the pulse. Both pulsed 20T magnetic field coils and steady state plasma confinement in torsatrons are feasible.

A fusion system fueled by deuterium and helium3 has a low threshold of fusion, due to the strong collisional coupling between the energetic alpha particles produced by fusion and the doubly charged helium3 nuclei. This means fusion energy produced in the system heats the remaining fusion fuel very efficiently, making it more reactive. This means that a small amount of tritium can be introduced into the system to bring it to fusion. Tritium fuses at lower temperatures and thus heats the plasma ions via fusion energy. This would however, introduce neutrons into the system and cause some activation of the structure.

The fusion confinement device 110 in various implementations can be constructed of high strength aluminum alloy and weigh approximately a ton. In some implementations, the fusion system 100, adding small amounts of yttrium and scandium to aluminum of the first half-shell 114 and the second half-shell 116 will increase the strength while not affecting electrical conductivity.

A chamber filled with a mixture of helium3 and deuterium and a fast-rising magnetic pulse reaching approximately 0.2 MegaGauss in strength, that creates an imploding shockwave in the plasma. Numbers used here must be considered as approximate and empirical as the formation, implosion, and stagnation processes of the shockwave used to heat the plasma are known to involve many non-linear processes. Shock speed will be approximately determined by the initial plasma mass density and the magnetic field strength during the implosion phase. The initial mass density, ρₒ is:

$${ρ}_{o} = 1.9 \times {10}^{3} / {cm}^{3} * 4.2 \times {10}^{- 24} g = 1.3 \times {10}^{- 7} g / {cm}^{3}$$

The approximate shock speed will then be: Vₛ≅(B²/(8πρ))¹/²=5×10⁸ cm/sec, where B is magnetic field strength and p is mass density (in grams/cc), much higher than the thermal speed at 60 KeV (2.2×10⁸ cm/sec) corresponding to a temperature of 300 KeV (300 million degrees K) and thus more than sufficient to trigger fusion in the deuterium and helium3 plasma. However, empirically, this high temperature tends to be reduced, by a variety of loss processes, in the final stagnated plasma state, by approximately an order of magnitude.

After stagnation of the plasma shockwave the magnetic field energy density will “equipartition” with the thermodynamic energy in the plasma resulting in a plasma of energy density of approximately 3B²/(87), the same as in the magnetic field but multiplied by an efficiency factor R 100%. Ideally, the efficiency factor R=100% but empirical evidence indicates this is actually 4% in actual toroidal magnetic confinement devices.

This means confining an MHD stable plasma in a torsatron at the deuterium and helium3 nt (Lawson criterion)=10⁵ see/cm³, of approximate number density 10¹⁶/cm³, assuming a confinement time of 0.1 second. The pulsed magnetic fields of 0.2 MegaGuass peak value, required to satisfy the p requirement to confine the hot deuterium and helium3 fusion plasma satisfying the triple product, nkTt (Lawson criterion times plasma temperature) 50 atmosphere-seconds, meaning a pressure of 500 atmospheres. This will require, in turn, pulsed magnetic fields of 0.2 mega-gauss peak value. Such fields are achievable but will exert pressures of 12×10³ atmospheres on the structure of the systems, methods and apparatus described herein, requiring alloys of high strength and high electrical conductivity. This high magnetic field also ensures that high energy protons and high energy nuclei produced by the fusion reactions are confined in the plasma to heat the plasma.

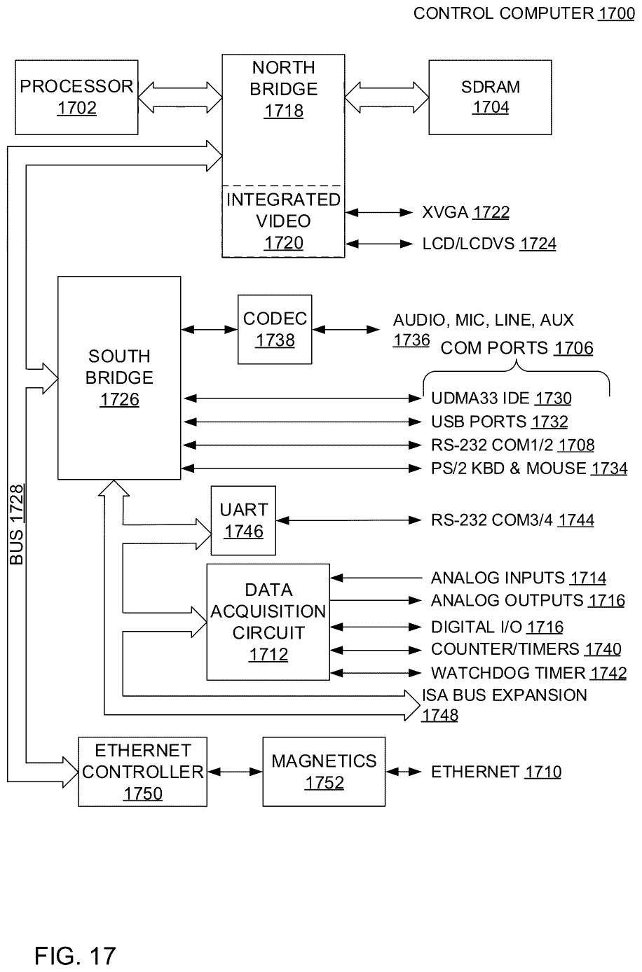

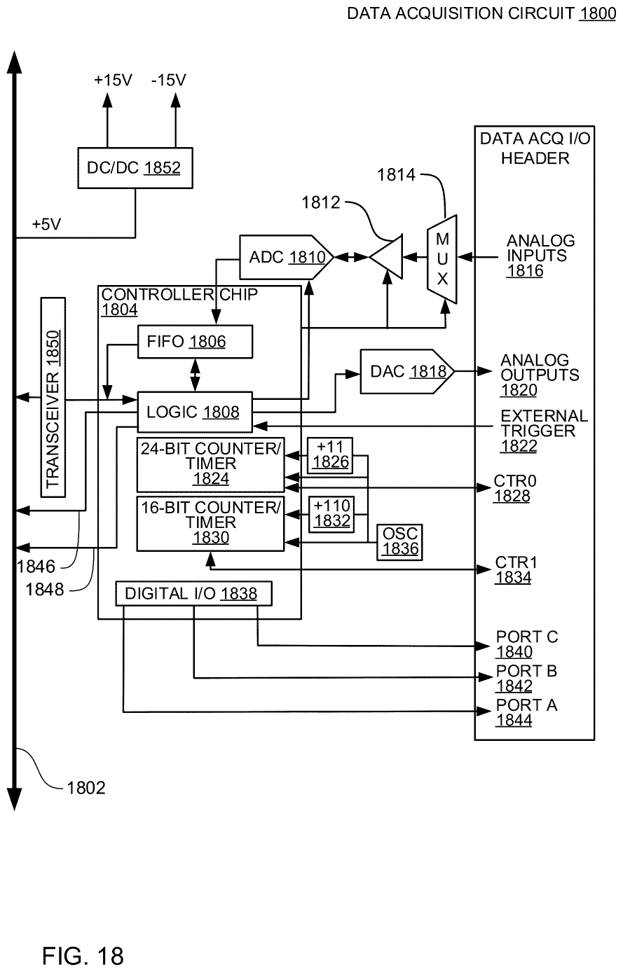

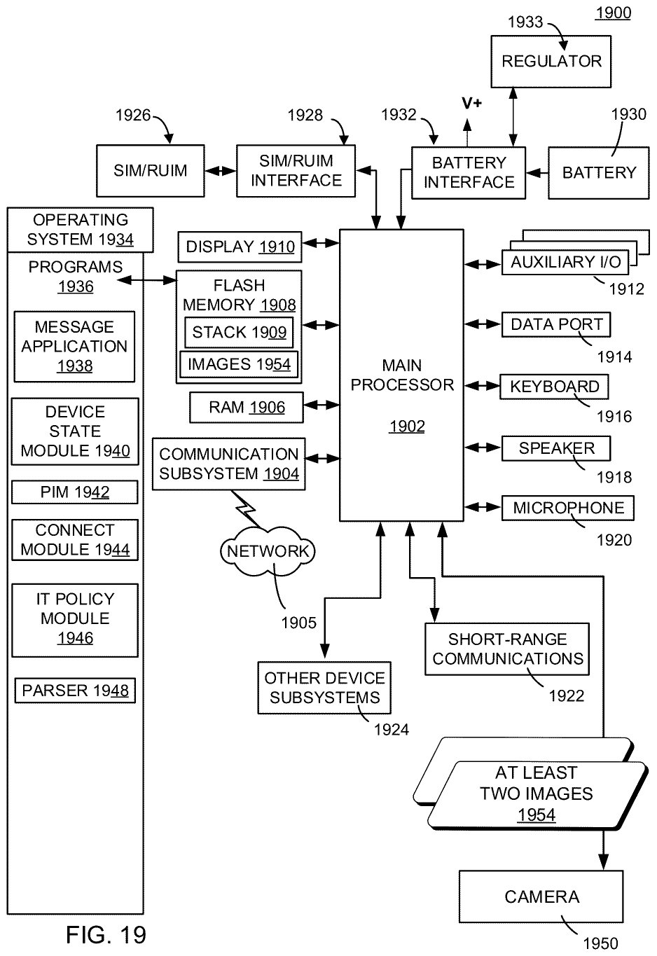

A processor, such as processor 1702 in FIG. 17, controller chip 1804 in FIG. 18 or main processor 1902 in FIG. 19, cause the processor to control the fusion system 100 in a manner of controlled fusion. More specifically, the processor controls the vacuum pump 134, the vacuum port 138, the fuel injector 140, the fuel tank 144, the gas injector 146 and the gas tank 150, the gas sensor 154, the electrical source 158, the electrical source 164, the electrical switch 166, the electrical source 174 and the electrical sink 176.

Some implementations of the fusion system 100 include a Langmuir probe and spectral density and temperature plasma diagnostic hardware and software.

In some implementations, the fusion system 100 performs plasma heating and confinement at 100 eV and 1000 liters in volume.

In some implementations, the fusion system 100 can be used in fusion reaction experiments.

In some implementations, the fusion system 100 can include hardware and software to perform multipoint spectral density and temperature plasma diagnostics.

In some implementations, the fusion system 100 performs plasma heating and confinement up to 60 KeV and 1000 liters in volume.

In some implementations, the fusion system 100 includes hardware and software performs neutron and proton detector-based density and temperature plasma diagnostics to monitor fusion reactions.

In some implementations, the fusion system 100 performs plasma heating and confinement up to 30 to 60 KeV and 1000 liters in volume.

In some implementations, the fusion system 100 performs deuterium and helium3 fusion plasma heating and confinement up to 30-60 KeV and 1000 liters in volume.

In some implementations, the fusion system 100 performs plasma heating and confinement of deuterium and helium3 at 30 to 60 KeV and 10¹⁵/cm³ for 100 millisecond pulses.

In some implementations, the fusion system 100 performs plasma deuterium and helium3 fusion.

In some implementations, the fusion system 100 performs deuterium and helium3 fusion confinement for experimental use while minimizing neutron output.

A torsatron is the simplest configuration for toroidal magnetic confinement of plasmas in steady state. The formation of toroidal plasmas with “flux invariants” can lead to stable MHD (Magneto-Hydro-Dynamic) equilibria, after a period of relaxation to a minimum energy state.

In some implementations, the fusion system 100 performs stable plasma equilibrium for a deuterium and helium3 mixture using shock heating and subsequent confinement of a dense-hot plasma for 100 milliseconds at a number density of approximately nₑ=10¹⁷ electrons per cc. The magnetic field required for this is approximately 500 kG.

The systems, methods and apparatus described herein is a configuration that is simple, effective, and “user friendly” and that easily confines stable plasmas of nₑ=1000 liters in volume and electron and ion temperatures of 200 eV.

The systems, methods and apparatus described herein configuration at deuterium and helium3, will allow compact high power pulsed aneutronic fusion energy for experimental use, without radiation or nuclear waste, with the direct conversion of fusion power to electricity.

In some implementations, the fusion system 100 performs plasma equilibrium with centrally peaked profiles, controlled by computer hardware and software, such as FIG. 17-19, that is coupled to the fusion system 100, performs detailed profile diagnostics and optical diagnostics using the visible line spectra of ionized helium at 320.3 nm and 468.5 nm to determine the ion temperature and electron density in the plasma core. In some implementations, these measurements are augmented at higher ion densities and temperatures in some implementations of the systems, methods and apparatus described herein with measurements of neutron emission from deuterium-deuterium fusion reactions and at higher temperatures high energy protons from the deuterium and helium3 reactions.

In regards to plasma physics, nuclear physics and power engineering issues, in MHD (Magneto-Hydro-Dynamic) equilibrium and stability, the parameter measuring the efficiency of the magnetic field in confining the plasma is termed p and the ratio of average thermodynamic pressure in the plasma to the average magnetic energy density. High 3 equilibria is most desirable; however, they are more susceptible to MHD instabilities, that leads to plasma escape. A “second region” of stability exist with stable equilibria up to β˜4%.

In regards to suppression of deuterium-deuterium neutronic side reactions, a hot plasma containing both deuterium and helium3 will burn primarily deuterium and helium3, however deuterium-deuterium side reactions will also occur unless the deuterium can be kept at lower temperature. This will occur naturally in the initial shock heating phase of the pulsed plasma when most of the kinetic energy will be contained in the heavier helium3. However, in some cases, the deuterium will reach the same temperatures as the helium3 and deuterium-deuterium fusion reactions, which will create neutrons. The helium3 can be heated preferentially while keeping the deuterium cold and thus suppressing deuterium-deuterium reactions. Nonetheless, both the helium3 and deuterium can be spin polarized in the magnetic fields and that this polarized plasma promotes deuterium and helium3 fusion but suppress deuterium-deuterium reactions. Therefore, deuterium-deuterium reactions can be suppressed in the plasma by various methods and so the resulting neutron emission can also be sharply reduced in final systems.

The high temperature plasma required to burn deuterium and helium3 leads to high energy electrons that are mildly relativistic and this leads to enhanced microwave emission by the plasma. This microwave emission is at high frequency compared to the normal cyclotron emission which is much more intense, is called synchrotron radiation. This requires having highly reflective inner walls for the inner chamber 118 to reflect power back into the plasma where it is reabsorbed. In some implementations, the inner walls of the inner chamber 118 can be made highly reflective to synchroton radiation (high frequency microwaves) by being made of pure 100% aluminum. Alternatively, synchrotron radiation can extract power at high efficiency from the plasma since microwave antenna arrays can be fabricated which directly convert synchrotron radiation to electricity.

In some implementations, the fusion system 100 is optimized to burn deuterium and helium3 by injecting of a small percentage (e.g. less than 5%) of tritium into the inner chamber 118. The tritium fuses instantly at the high temperatures required for deuterium and helium3 fusion and the resulting 4.5 Mev helium4 (alpha particles) collide with and heat of the helium3 to even higher temperature, igniting the plasma.

In some implementations, the fuel in the fusion system 100 will fuse in a non-equilibrium mode, which is undesirable, in which case the deuterium and helium3 fuel can be mixed with a lean mixture of deuterium since most of the initial kinetic energy will be in the helium3 (because the helium3 is heavier and also because the helium3 will be heated more effectively by collisions with fusion helium4. In some implementations, additional suppression of deuterium-deuterium fusion reaction can be achieved by using polarized fuels, which enhances deuterium and helium3 reaction but suppresses deuterium-deuterium reactions. In some implementations, the fusion system 100, the same plasma-magnetic field dynamics that lead to plasma implosion for shock heating can be reversed to harvest fusion energy from the expanding hot plasma as it presses outward on the confining magnetic field.

While the fusion system 100 is not limited to any particular fusion confinement device 110, first half-shell 114, second half-shell 116, inner chamber 118, flange 120, flange 122, insulation layer 124, non-ferrous and non-conductive fasteners 126 and 128, terminal 130, terminal 132, vacuum pump 134, vacuum line 136, vacuum port 138, fuel injector 140, fuel line 142, fuel tank 144, gas injector 146, gas line 148, EM foil 152, gas tank 150, gas sensor 154, electric line 156, electrical source 158, pre-ionizer 160, electric line 162, electrical source 164, electrical switch 166, electric line 168, electric line 170, conductive center piece 172, electrical source 174, electrical sink 176, and for sake of clarity a simplified fusion confinement device 110, first half-shell 114, second half-shell 116, inner chamber 118, flange 120, flange 122, insulation layer 124, non-ferrous and non-conductive fasteners 126 and 128, terminal 130, terminal 132, vacuum pump 134, vacuum line 136, vacuum port 138, fuel injector 140, fuel line 142, fuel tank 144, gas injector 146, gas line 148 and gas tank 150, EM foil 152, gas sensor 154, electric line 156, electrical source 158, pre-ionizer 160, electric line 162, electrical source 164, electrical switch 166, electric line 168, electric line 170, conductive center piece 172, electrical source 174 and electrical sink 176 are described.

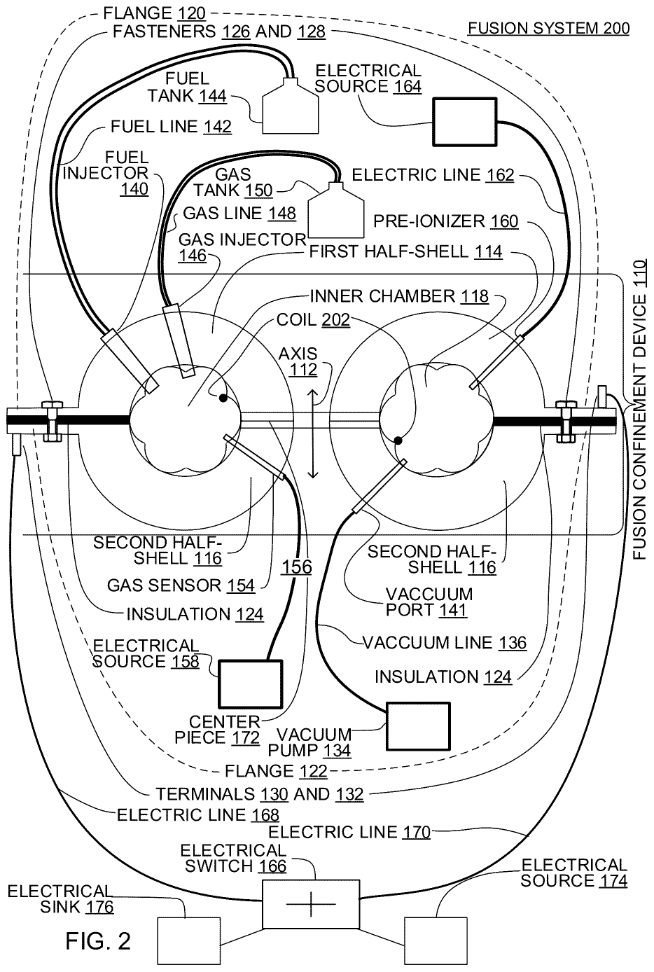

FIG. 2 is an isometric cross section block diagram of a wire-coil torsatron operable in the fusion system 200, according to an implementation.

A coil 202 is a spiraled wire that is mounted or attached to a ridge of the inner chamber 118. Electricity passes through the coil 202. In some implementations, all of the coil(s) 202 are physically mounted in regards to the rifling, on the land(s) (the highpoint) between the grooves, such as shown in FIG. 2. In other implementations, all of the coil(s) 202 are mounted in the grooves (the low point) between the ridges (ridges).

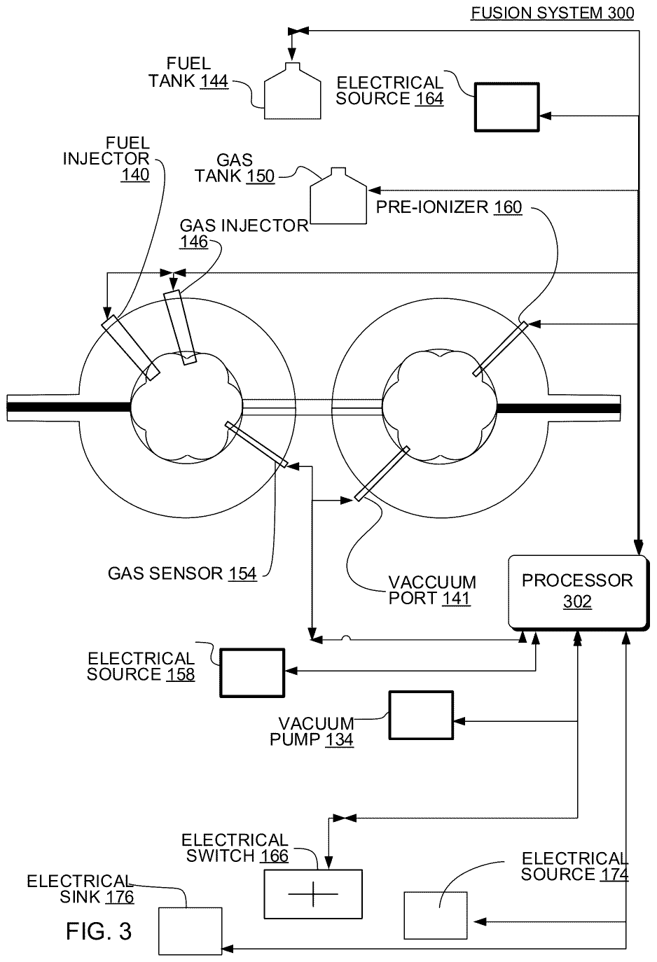

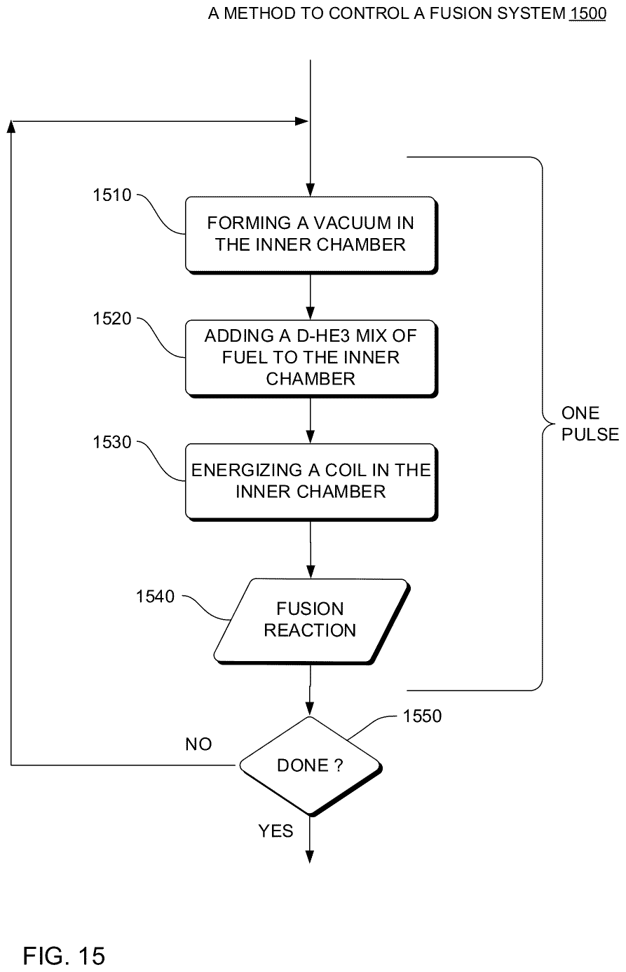

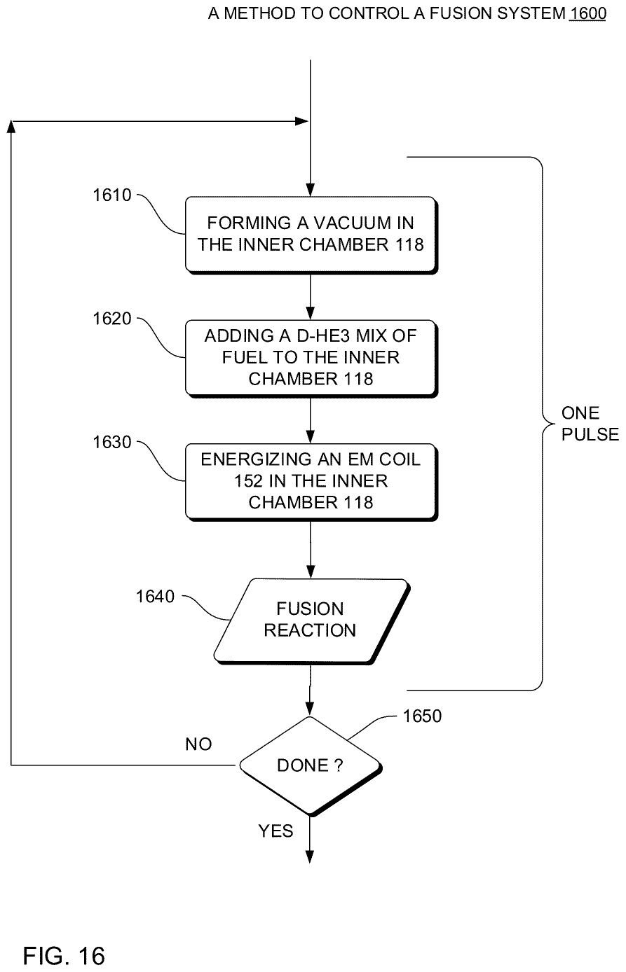

FIG. 3 is block diagram of a fusion control system 300, according to an implementation. In fusion control system 300, a processor 302 controls all or some of the electrical components in FIG. 3. Examples of the processor 302 include processor 1702 in FIG. 17, controller chip 1804 in FIG. 18 or main processor 1902 in FIG. 19. In some implementations, the method in FIG. 15 or FIG. 16 is performed by processor 302 to control components in the fusion control system 300, components such as the vacuum pump 134, fuel injector 140, vacuum port 141, fuel tank 144, gas injector 146, gas tank 150, gas sensor 154, pre-ionizer 160, electrical source 164, electrical switch 166, electrical source 174 and/or the electrical sink 176.

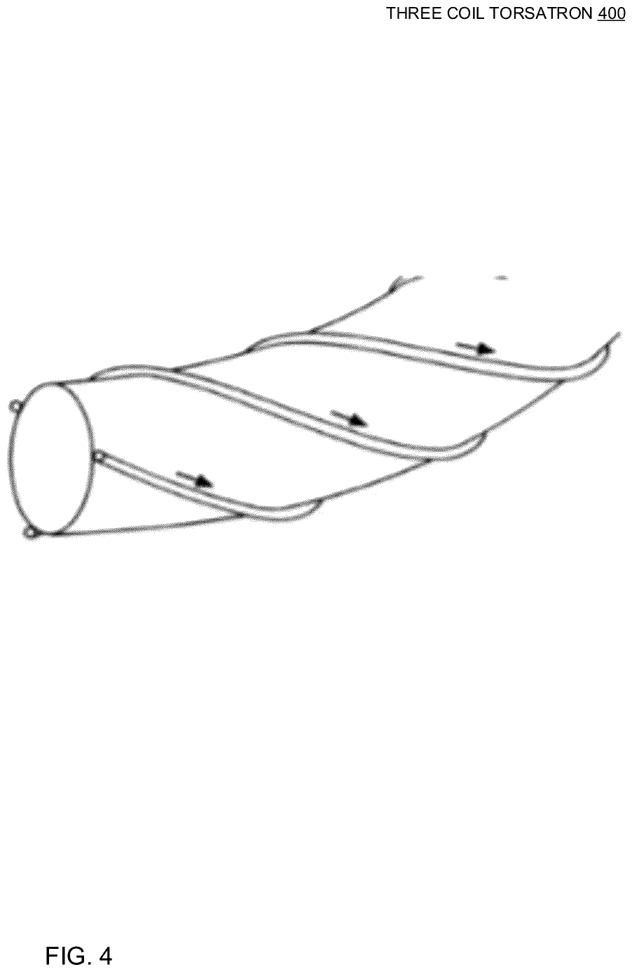

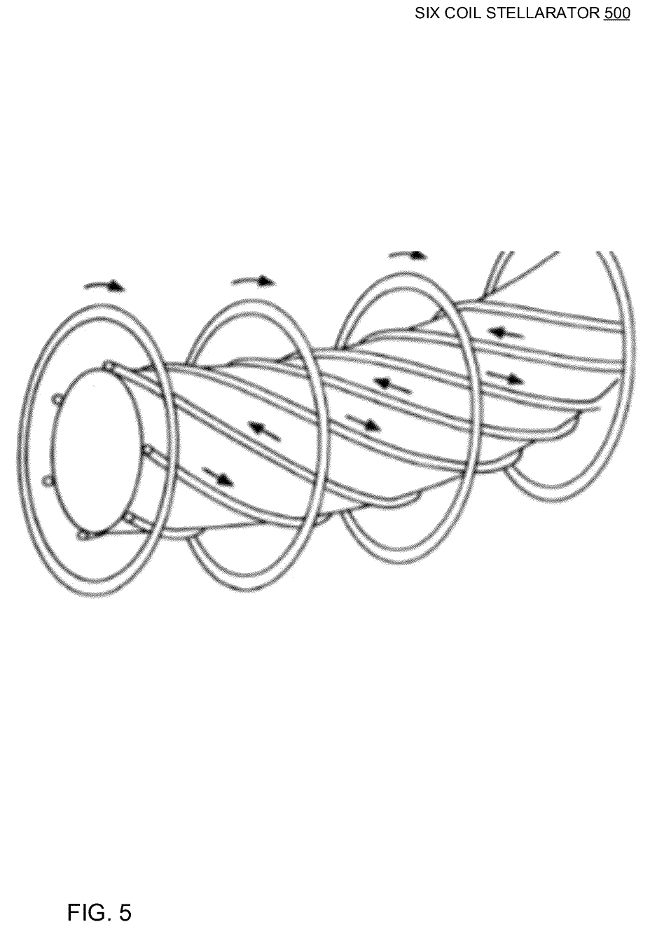

FIG. 4 is an isometric cross section block diagram of a three-coil torsatron operable in the fusion system 200 in FIG. 2, according to an implementation.

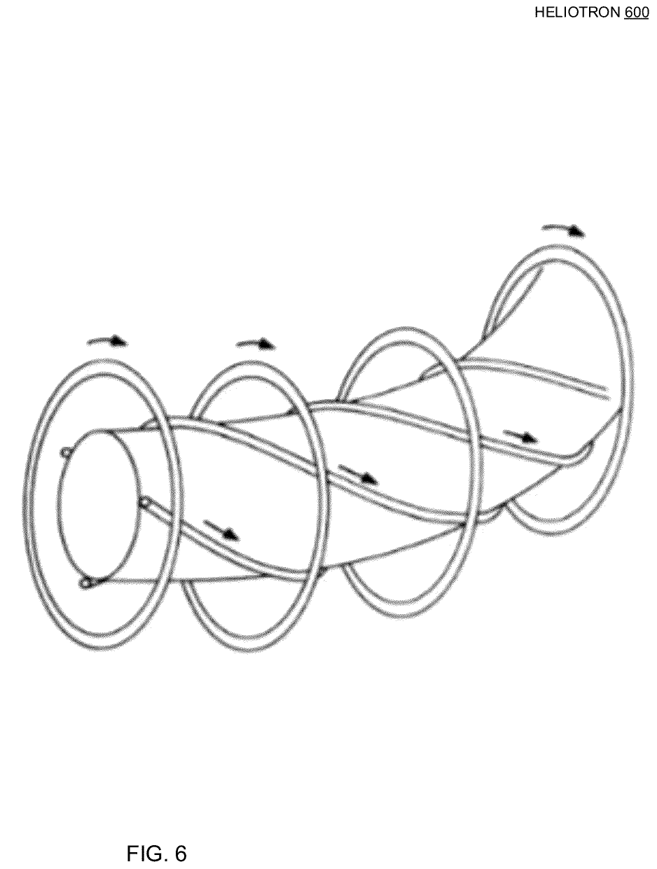

FIG. 5 is an isometric cross section block diagram of a six-coil stellarator operable in the fusion confinement device 102 in FIG. 2, according to an implementation.

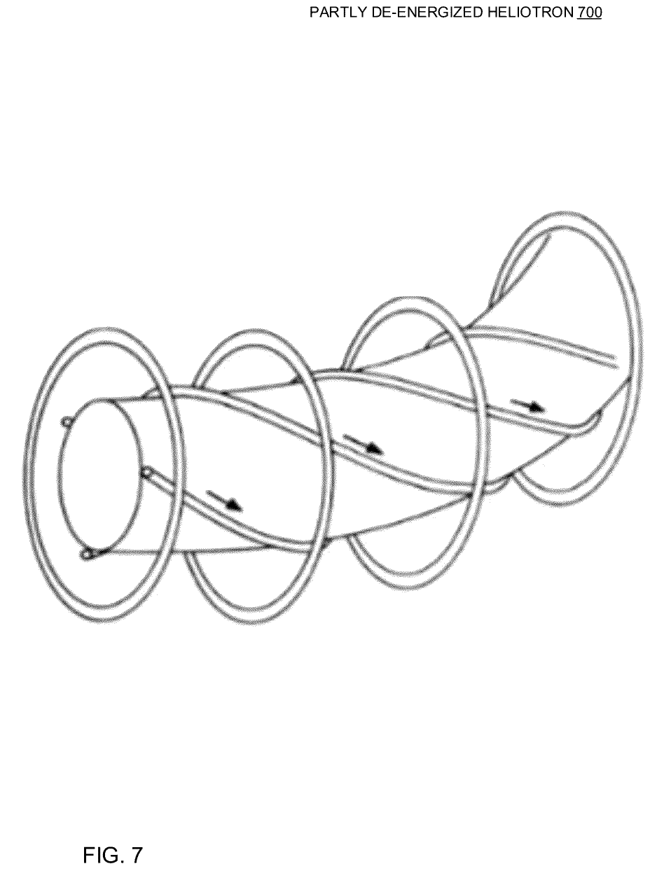

FIG. 6 is an isometric cross section block diagram of a heliotron operable in the fusion confinement device 102 in FIG. 2, according to an implementation.

FIG. 7 is an isometric cross section block diagram of a partly de-energized heliotron operable in the fusion confinement device 102 in FIG. 2, according to an implementation.

FIG. 8 is an isometric diagram of a half-shell 800 of a six-coil torsatron operable in the fusion confinement device in FIG. 1, according to an implementation. The half-shell 800 is the first half-shell 114 or the second half-shell 116 in FIG. 1.

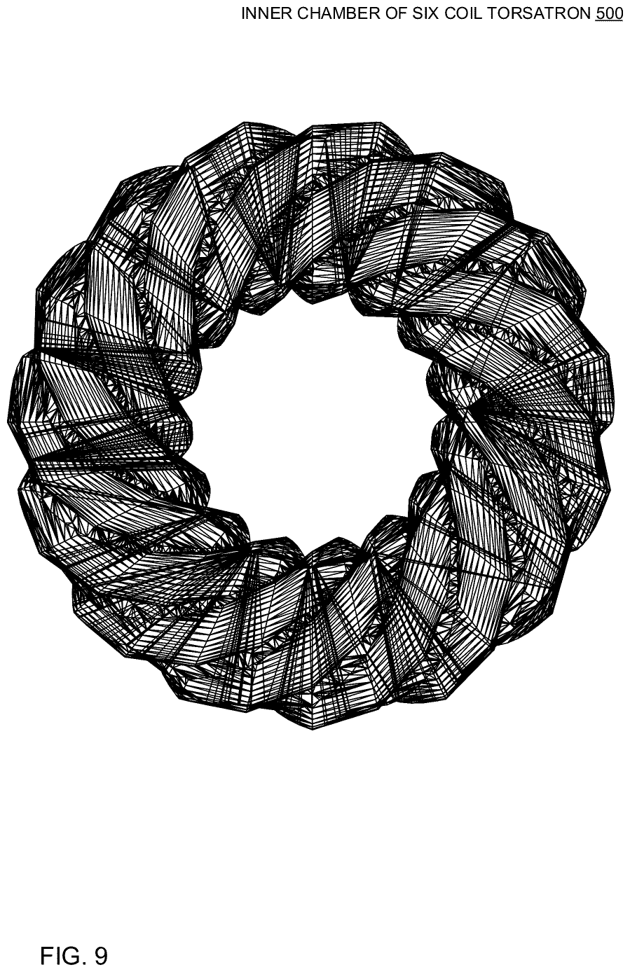

FIG. 9-13 are isometric diagrams of a six-coil torsatron operable in the fusion confinement device 102 in FIG. 2, according to an implementation. The diagrams in FIG. 9-13 show the approximate contours of the outer perimeter of the inner chamber 118 of the fusion confinement device 102 in FIG. 2. The diagrams in FIG. 9-13 show a theta pinch device in which the magnetic field runs down the axis of the inner chamber, while the electric field is in the azimuthal direction.

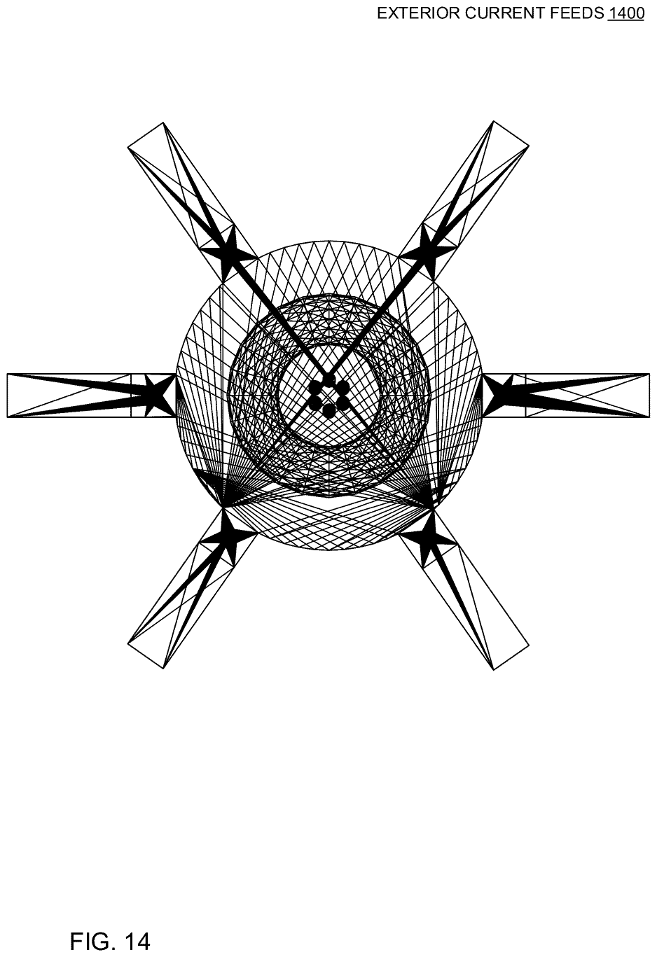

FIG. 14 is an isometric diagram of a six-lead exterior current feed configuration of a fusion confinement device 1400, according to an implementation. The configuration shown in FIG. 14 is suitable for use by the fusion confinement device 110 in FIG. 2.

### Method Implementations

In the previous section, apparatus of the operation of an implementation was described. In this section, the particular methods performed by the fusion system 100 in FIG. 1 and the fusion system 200 in FIG. 2 of such an implementation are described by reference to a series of flowcharts.

FIG. 15 is a flowchart of a method 1500 to control a pulsed fusion system, according to an implementation. Method 1500 provides control of a fusion system having a rifled toroidal theta pinch (RTTP). Method 1500 can be performed multiple times in quick succession, in order to pulse fusion reactions, in comparison to steady-state fusion reactors which maintain a state of constant fusion reactions over much longer periods of time.

Method 1500 includes forming 1510 a vacuum in an inner chamber of a fusion confinement device. When block 1510 is performed for the first time after an absence of activity of at least a few minutes, if not a few days or few months, block 1510 vents the inner chamber to clear helium4 ash, thus preparing the fusion confinement device for a new pulse of fusion reaction.

Method 1500 thereafter includes adding 1520 a deuterium-helium3 mix of fuel to the inner chamber of the fusion confinement device. In one implementation, the total length of time to perform blocks 1510 and 1520 for the first time is about 5 s (about 0.000005 second), thereafter, the length of time to perform blocks 1510 and 1520 is about 6 μs (about 0.000006 second).

Method 1500 thereafter includes energizing 1530 a first half-shell of the fusion confinement device, which energizes a coil, leading to an intense magnetic field at the walls of the rifled toroidal chamber, thereby forming and pushing a plasma inward. In one implementation, the length of time to perform block 1530 is about 5 μs (about 0.000005 second). Thereafter, a shock wave forms in the plasma on walls of the inner chamber and implodes inward toward a magnetic field on the outside of the plasma shockwave. In one implementation, the length of time to form the shock wave and implode the plasma shockwave is about 5 μs (about 0.000005 second). Thereafter, shock waves collide in the center of the inner chamber, thereby shock heating the plasma to fusion temperatures of between 100,000,000 degrees F. and 150,000,000 degrees F. In one implementation, the length of time for the shock waves to collide and for the shock heating to occur is about 5 μs (about 0.000005 second). Thereafter, the plasma relaxes into stable magnetic-plasma equilibrium. In one implementation, the length of time for the plasma to relax is about 5 μs (about 0.000005 second). Thereafter, the fuel in the plasma undergoes fusion reaction and expands pushing against the magnetic field to force the magnetic back into the walls, thereby generating electricity to recharge the electrical source 174 of the EM foil 152 and the coil 202, at block 1540. In one implementation, the length of time of the fusion reaction is about 1 ms (about 0.0010 second).

In some implementations, the energizing 1530 of the first half-shell of the fusion confinement device is continued during the formation of the intense magnetic field, the formation and pushing of the plasma inward, the formation of the shock wave in the plasma, the implosion of the plasma inward toward the magnetic field, the collision of the shock waves and the shock heating of the plasma to fusion temperatures and relaxation of the plasma and until the beginning of the fusion reaction.

Performance of the blocks, 1510, 1520, 1530 and 1540 in FIG. 15 produces a pulse of fusion reaction. One pulse of fusion reaction is the performance of blocks 1510, 1520, 1530 and 1540. The time of one pulse is approximately 1 ms (about 0.001 second), thus in the method 1500 in FIG. 15, the number of fusion pulses that can be performed in one second is approximately 1000. In some implementations, 60 pulses is performed each second.

At block 1550, when no further pulsing (blocks 1510, 1520, 1530, and 1540) is required or desired, the method ends, otherwise, the method 1500 is repeated starting at block 1510.

FIG. 16 is a flowchart of a method 1600 to control a pulsed fusion system, according to an implementation. Method 1600 provides control of a fusion system having a rifled toroidal theta pinch (RTTP), such as fusion systems 100 and 200. Method 1600 can be performed multiple times in quick succession, in order to pulse fusion reactions, in comparison to steady-state fusion reactors which maintain a state of constant fusion reactions over much longer periods of time.

Method 1600 includes forming 1610 a vacuum in an inner chamber 118 of fusion confinement device 110 in FIG. 1 and FIG. 2. When block 1610 is performed for the first time after an absence of activity of at least a few minutes, if not a few days or few months, block 1610 vents the inner chamber 118 to clear helium4 ash, thus preparing the fusion confinement device for a new pulse of fusion reaction.

Method 1600 thereafter includes adding 1620 a deuterium-helium3 mix of fuel to the inner chamber 118 of the fusion confinement device 110 in FIG. 1 or FIG. 2. In one implementation, the total length of time to perform blocks 1610 and 1620 for the first time is about 5 μs (about 0.000005 second), thereafter, the length of time to perform blocks 1610 and 1620 is about 6 μs (about 0.000006 second).

Method 1600 thereafter includes energizing 1630 a first half-shell of the fusion confinement device 110, which energizes an EM foil 152, leading to an intense magnetic field at the walls of the rifled toroidal chamber, thereby forming and pushing a plasma inward. In one implementation, the length of time to perform block 1630 is about s (about 0.000005 second). Thereafter, a shock wave forms in the plasma on walls of the inner chamber and implodes inward toward a magnetic field on the outside of the plasma shockwave. In one implementation, the length of time to form the shock wave and implode the plasma shockwave is about 5 μs (about 0.000005 second). Thereafter, shock waves collide in the center of the inner chamber 118, thereby shock heating the plasma to fusion temperatures of between 100,000,000 degrees F. and 150,000,000 degrees F. In one implementation, the length of time for the shock waves to collide and for the shock heating to occur is about 5 μs (about 0.000005 second). Thereafter, the plasma relaxes into stable magnetic-plasma equilibrium. In one implementation, the length of time for the plasma to relax is about 5 μs (about 0.000005 second). Thereafter, the fuel in the plasma undergoes fusion reaction and expands pushing against the magnetic field to force the magnetic back into the walls, thereby generating electricity to recharge the EM foil power supply, at block 1640. In one implementation, the length of time of the fusion reaction is about 1 ms (about 0.0010 second).

In some implementations, the energizing 1630 of the first half-shell of the fusion confinement device 110 is continued during the formation of the intense magnetic field, the formation and pushing of the plasma inward, the formation of the shock wave in the plasma, the implosion of the plasma inward toward the magnetic field, the collision of the shock waves and the shock heating of the plasma to fusion temperatures and relaxation of the plasma and until the beginning of the fusion reaction.

Performance of the blocks, 1610, 1620, 1630 and 1640 in FIG. 16 produces a pulse of fusion reaction. One pulse of fusion reaction is the performance of blocks 1610, 1620, 1630 and 1640. The time of one pulse is approximately 1 ms (about 0.001 second), thus in the method 1600 in FIG. 16, the number of fusion pulses that can be performed in one second is approximately 1000. In some implementations, 60 pulses is performed each second.

At block 1650, when no further pulsing (blocks 1610, 1620, 1630, and 1640) is required or desired, the method ends, otherwise, the method 1600 is repeated starting at block 1610.

In some implementations, methods 1500 and 1600 are implemented as a sequence of instructions which, when executed by a processor, such as processor 1702 in FIG. 17, controller chip 1804 in FIG. 18 or main processor 1902 in FIG. 19, cause the processor to perform the respective method. In other implementations, methods 1500 and 1600 are implemented as a computer-accessible medium having executable instructions capable of directing a processor, such as such as processor 1702 in FIG. 17, controller chip 1804 in FIG. 18 or main processor 1902 in FIG. 19, to perform the respective method. In varying implementations, the medium is a magnetic medium, an electronic medium, or an optical medium.

### Hardware and Operating Environment

FIG. 17 is a block diagram of a fusion system control computer 1700, according to an implementation. The fusion system control computer 1700 includes a processor 1702 (such as a Pentium III processor from Intel Corp. in this example) which includes dynamic and static ram and non-volatile program read-only-memory (not shown), operating memory 1704 (SDRAM in this example), communication ports 1706 (e.g, RS-232 1708 COM1/2 or Ethernet 1710), and a data acquisition circuit 1712 with analog inputs 1714 and outputs and digital inputs and outputs 1716.

In some implementations of the fusion system control computer 1700, the processor 1702 and the operating memory 1704 are coupled through a bridge 1718. In some implementations of the fusion system control computer 1700, the bridge 1718 includes a video port 1720 having display outputs 1722 and 1724.

In some implementations of the fusion system control computer 1700, the ports communication ports 1706 are coupled through a bridge 1726 and a bus 1728 to the bridge 1718. In some implementations of the fusion system control computer 1700, the RS-232 1708 communication port 1706 also includes an integrated drive electronics (IDE) port 1730 such as an ultra direct memory access 33 (UDMA33) port, and universal serial bus (USB) ports 1732, and a PS/2 keyboard and mouse port 1734. In some implementations of the fusion system control computer 1700, a port 1736 for audio, microphone, line and auxiliary devices is coupled through a coder/decoder (CODEC) 1738 to the bridge 1726.

In some implementations of the fusion system control computer 1700, the data acquisition circuit 1712 is also coupled to counter timer ports 1740 and watchdog timer ports 1742. In some implementations of the fusion system control computer 1700, an RS-232 port 1744 is coupled through a universal asynchronous receiver/transmitter (UART) 1746 to the bridge 1726.

In some implementations of the fusion system control computer 1700, an industry standard architecture (ISA) bus expansion port is coupled to the bridge 1726. In some implementations of the fusion system control computer 1700, the Ethernet port 1710 is coupled to the bus 1728 through an Ethernet controller 1750 and a magnetics 1752.

FIG. 18 is a block diagram of a data acquisition circuit 1800 of fusion system control computer 1700 in FIG. 17, according to an implementation. The data acquisition circuit is one example of the data acquisition circuit 1712 in FIG. 17 above. Some implementations of the data acquisition circuit 1800 provide 16-bit A/D performance with input voltage capability up to +/−10V, and programmable input ranges.

The data acquisition circuit 1800 includes a bus 1802, such as a conventional PC/104 bus. The data acquisition circuit 1800 is operably coupled to a controller chip 1804. Some implementations of the controller chip 1804 include an analog/digital first-in/first-out (FIFO) buffer 1806 that is operably coupled to controller logic 1808. In some implementations of the data acquisition circuit 1800, the FIFO 1806 receives signal data from and analog/digital converter (ADC) 1810, which exchanges signal data with a programmable gain amplifier 1812, which receives data from a multiplexer 1814, which receives signal data from analog inputs 1816.

In some implementations of the data acquisition circuit 1800, the controller logic 1808 sends signal data to the ADC 1810 and a digital/analog converter (DAC) 1818. The DAC 1818 sends signal data to analog outputs. In some implementations of the data acquisition circuit 1800, the controller logic 1808 receives signal data from an external trigger 1822.

In some implementations of the data acquisition circuit 1800, the controller chip 1804 includes a 24-bit counter/timer 1824 that receives signal data from a +10 component 1826 and exchanges signal data with a “CTR 0” 1828. In some implementations of the data acquisition circuit 1800, the controller chip 1804 includes a 16-bit counter/timer 1830 that receives signal data from a +100 component 1832 and exchanges signal data with a “CTR 1” 1828. The 24-bit counter/timer 1824, the +10 component 1826, the 16-bit counter/timer 1830 and the +100 component 1832 all receive signal data from a oscillator (OSC) 1836.

In some implementations of the data acquisition circuit 1800, the controller chip 1804 includes a digital input/output (I/O) component 1838 that sends digital signal data to “port C” 1840, “port B” 1842 and “port A” 1844.

In some implementations of the data acquisition circuit 1800, the controller logic 1808 sends signal data to the bus 1802 via a control line 1846 and an interrupt line 1848. In some implementations of the data acquisition circuit 1800, the controller logic 1808 exchanges signal data to the bus 1802 via a transceiver 1850. In some implementations of the data acquisition circuit 1800, the bus supplies +5 volts of electricity to a DC-to-DC converter 1852, that in turn supplies +15V and −15V of electricity.

Some implementations of the data acquisition circuit 1800 include 4 12-bit D/A channels, 24 programmable digital I/O lines, and two programmable counter/timers. Placement of the analog circuitry away from the high-speed digital logic ensures low-noise performance for important applications. Some implementations of the data acquisition circuit 1800 are fully supported by operating systems that include DOS™ Linux™, RTLinux™, QNX™, Windows 98/NT/2000/XP/CE™, and VxWorks™ to simplify application development.

FIG. 19 is a block diagram of a fusion reactor control mobile device 1900, according to an implementation. The fusion reactor control mobile device 1900 includes a number of components such as a main processor 1902 that controls the overall operation of the fusion reactor control mobile device 1900. Communication functions, including data and voice communications, are performed through a communication subsystem 1904. The communication subsystem 1904 receives messages from and sends messages to a wireless network 1905. In this exemplary implementation of the fusion reactor control mobile device 1900, the communication subsystem 1904 is configured in accordance with the Global System for Mobile Communication (GSM), General Packet Radio Services (GPRS) standards, 3G, 4G, 5G and/or 6G. It will also be understood by persons skilled in the art that the implementations described herein are intended to use any other suitable standards that are developed in the future. The wireless link connecting the communication subsystem 1904 with the wireless network 1905 represents one or more different Radio Frequency (RF) channels, operating according to defined protocols specified for 4G or 5G communications. With newer network protocols, these channels are capable of supporting both circuit switched voice communications and packet switched data communications.

Although the wireless network 1905 associated with fusion reactor control mobile device 1900 is a GSM/GPRS, 3G, 4G, 5G and/or 6G wireless network in one exemplary implementation, other wireless networks may also be associated with the fusion reactor control mobile device 1900 in variant implementations. The different types of wireless networks that may be employed include, for example, data-centric wireless networks, voice-centric wireless networks, and dual-mode networks that can support both voice and data communications over the same physical base stations. Combined dual-mode networks include, but are not limited to, Code Division Multiple Access (CDMA) or CDMA2000 networks, GSM/GPRS networks, 3G, 4G, 5G and/or 6G. Some other examples of data-centric networks include WiFi 802.11, Mobitex™ and DataTAC™ network communication systems. Examples of other voice-centric data networks include Personal Communication Systems (PCS) networks like GSM and Time Division Multiple Access (TDMA) systems.

The main processor 1902 also interacts with additional subsystems such as a Random Access Memory (RAM) 1906, a flash memory 1908, a display 1910, an auxiliary input/output (I/O) subsystem 1912, a data port 1914, a keyboard 1916, a speaker 1918, a microphone 1920, short-range communications 1922 and other device subsystems 1924.

Some of the subsystems of the fusion reactor control mobile device 1900 perform communication-related functions, whereas other subsystems may provide “resident” or on-device functions. By way of example, the display 1910 and the keyboard 1916 may be used for both communication-related functions, such as entering a text message for transmission over the wireless network 1905, and device-resident functions such as a calculator or task list.

The fusion reactor control mobile device 1900 can send and receive communication signals over the wireless network 1905 after required network registration or activation procedures have been completed. Network access is associated with a subscriber or user of the fusion reactor control mobile device 1900. To identify a subscriber, the fusion reactor control mobile device 1900 requires a SIM/RUIM card 1926 (i.e. Subscriber Identity Module or a Removable User Identity Module) to be inserted into a SIM/RUIM interface 1928 in order to communicate with a network. The SIM card or RUIM 1926 is one type of a conventional “smart card” that can be used to identify a subscriber of the fusion reactor control mobile device 1900 and to customize the fusion reactor control mobile device 1900, among other aspects. Without the SIM card 1926, the fusion reactor control mobile device 1900 is not fully operational for communication with the wireless network 1905. By inserting the SIM card/RUIM 1926 into the SIM/RUIM interface 1928, a subscriber can access all subscribed services. Services may include: web browsing and messaging such as e-mail, voice mail, Short Message Service (SMS), and Multimedia Messaging Services (MMS). More advanced services may include: point of sale, field service and sales force automation. The SIM card/RUIM 1926 includes a processor and memory for storing information. Once the SIM card/RUIM 1926 is inserted into the SIM/RUIM interface 1928, it is coupled to the main processor 1902. In order to identify the subscriber, the SIM card/RUIM 1926 can include some user parameters such as an International Mobile Subscriber Identity (IMSI). An advantage of using the SIM card/RUIM 1926 is that a subscriber is not necessarily bound by any single physical mobile device. The SIM card/RUIM 1926 may store additional subscriber information for a mobile device as well, including datebook (or calendar) information and recent call information. Alternatively, user identification information can also be programmed into the flash memory 1908.

The fusion reactor control mobile device 1900 is a battery-powered device and includes a battery interface 1932 for receiving one or more rechargeable batteries 1930. In one or more implementations, the battery 1930 can be a smart battery with an embedded microprocessor. The battery interface 1932 is coupled to a regulator 1933, which assists the battery 1930 in providing power V+ to the fusion reactor control mobile device 1900. Although current technology makes use of a battery, future technologies such as micro fuel cells may provide the power to the fusion reactor control mobile device 1900.

The fusion reactor control mobile device 1900 also includes an operating system 1934 and software components 1936 to 1948 which are described in more detail below. The operating system 1934 and the software components 1936 to 1948 that are executed by the main processor 1902 are typically stored in a persistent store such as the flash memory 1908, which may alternatively be a read-only memory (ROM) or similar storage element (not shown). Those skilled in the art will appreciate that portions of the operating system 1934 and the software components 1936 to 1948, such as specific device applications, or parts thereof, may be temporarily loaded into a volatile store such as the RAM 1906. Other software components can also be included.

The subset of software components 1936 that control basic device operations, including data and voice communication applications, will normally be installed on the fusion reactor control mobile device 1900 during its manufacture. Other software applications include a message application 1938 that can be any suitable software program that allows a user of the fusion reactor control mobile device 1900 to send and receive electronic messages. Various alternatives exist for the message application 1938 as is well known to those skilled in the art. Messages that have been sent or received by the user are typically stored in the flash memory 1908 of the fusion reactor control mobile device 1900 or some other suitable storage element in the fusion reactor control mobile device 1900. In one or more implementations, some of the sent and received messages may be stored remotely from the device 1900 such as in a data store of an associated host system with which the fusion reactor control mobile device 1900 communicates.

The software applications can further include a device state module 1940, a Personal Information Manager (PIM) 1942, and other suitable modules (not shown). The device state module 1940 provides persistence, i.e. the device state module 1940 ensures that important device data is stored in persistent memory, such as the flash memory 1908, so that the data is not lost when the fusion reactor control mobile device 1900 is turned off or loses power.

The PIM 1942 includes functionality for organizing and managing data items of interest to the user, such as, but not limited to, e-mail, contacts, calendar events, voice mails, appointments, and task items. A PIM application has the ability to send and receive data items via the wireless network 1905. PIM data items may be seamlessly integrated, synchronized, and updated via the wireless network 1905 with the mobile device subscriber's corresponding data items stored and/or associated with a host computer system. This functionality creates a mirrored host computer on the fusion reactor control mobile device 1900 with respect to such items. This can be particularly advantageous when the host computer system is the mobile device subscriber's office computer system.

The fusion reactor control mobile device 1900 also includes a connect module 1944, and an IT policy module 1946. The connect module 1944 implements the communication protocols that are required for the fusion reactor control mobile device 1900 to communicate with the wireless infrastructure and any host system, such as an enterprise system, with which the fusion reactor control mobile device 1900 is authorized to interface. Examples of a wireless infrastructure and an enterprise system are given in FIGS. 22 and 23, which are described in more detail below.

The connect module 1944 includes a set of APIs that can be integrated with the fusion reactor control mobile device 1900 to allow the fusion reactor control mobile device 1900 to use any number of services associated with the enterprise system. The connect module 1944 allows the fusion reactor control mobile device 1900 to establish an end-to-end secure, authenticated communication pipe with the host system. A subset of applications for which access is provided by the connect module 1944 can be used to pass IT policy commands from the host system to the fusion reactor control mobile device 1900. This can be done in a wireless or wired manner. These instructions can then be passed to the IT policy module 1946 to modify the configuration of the device 1900. Alternatively, in some cases, the IT policy update can also be done over a wired connection.

The IT policy module 1946 receives IT policy data that encodes the IT policy. The IT policy module 1946 then ensures that the IT policy data is authenticated by the fusion reactor control mobile device 1900. The IT policy data can then be stored in the flash memory 1906 in its native form. After the IT policy data is stored, a global notification can be sent by the IT policy module 1946 to all of the applications residing on the fusion reactor control mobile device 1900. Applications for which the IT policy may be applicable then respond by reading the IT policy data to look for IT policy rules that are applicable.

The IT policy module 1946 can include a parser 1948, which can be used by the applications to read the IT policy rules. In some cases, another module or application can provide the parser. Grouped IT policy rules, described in more detail below, are retrieved as byte streams, which are then sent (recursively) into the parser to determine the values of each IT policy rule defined within the grouped IT policy rule. In one or more implementations, the IT policy module 1946 can determine which applications are affected by the IT policy data and send a notification to only those applications. In either of these cases, for applications that are not being executed by the main processor 1902 at the time of the notification, the applications can call the parser or the IT policy module 1946 when they are executed to determine if there are any relevant IT policy rules in the newly received IT policy data.

All applications that support rules in the IT Policy are coded to know the type of data to expect. For example, the value that is set for the “WEP User Name” IT policy rule is known to be a string; therefore the value in the IT policy data that corresponds to this rule is interpreted as a string. As another example, the setting for the “Set Maximum Password Attempts” IT policy rule is known to be an integer, and therefore the value in the IT policy data that corresponds to this rule is interpreted as such.

After the IT policy rules have been applied to the applicable applications or configuration files, the IT policy module 1946 sends an acknowledgement back to the host system to indicate that the IT policy data was received and successfully applied.

Other types of software applications can also be installed on the fusion reactor control mobile device 1900. These software applications can be third party applications, which are added after the manufacture of the fusion reactor control mobile device 1900. Examples of third party applications include games, calculators, utilities, etc.

The additional applications can be loaded onto the fusion reactor control mobile device 1900 through at least one of the wireless network 1905, the auxiliary I/O subsystem 1912, the data port 1914, the short-range communications subsystem 1922, or any other suitable device subsystem 1924. This flexibility in application installation increases the functionality of the fusion reactor control mobile device 1900 and may provide enhanced on-device functions, communication-related functions, or both. For example, secure communication applications may enable electronic commerce functions and other such financial transactions to be performed using the fusion reactor control mobile device 1900.

The data port 1914 enables a subscriber to set preferences through an external device or software application and extends the capabilities of the fusion reactor control mobile device 1900 by providing for information or software downloads to the fusion reactor control mobile device 1900 other than through a wireless communication network. The alternate download path may, for example, be used to load an encryption key onto the fusion reactor control mobile device 1900 through a direct and thus reliable and trusted connection to provide secure device communication.

The data port 1914 can be any suitable port that enables data communication between the fusion reactor control mobile device 1900 and another computing device. The data port 1914 can be a serial or a parallel port. In some instances, the data port 1914 can be a USB port that includes data lines for data transfer and a supply line that can provide a charging current to charge the battery 1930 of the fusion reactor control mobile device 1900.

The short-range communications subsystem 1922 provides for communication between the fusion reactor control mobile device 1900 and different systems or devices, without the use of the wireless network 1905. For example, the subsystem 1922 may include an infrared device and associated circuits and components for short-range communication. Examples of short-range communication standards include standards developed by the Infrared Data Association (IrDA), Bluetooth, and the 802.11 family of standards developed by IEEE.

In use, a received signal such as a text message, an e-mail message, or web page download will be processed by the communication subsystem 1904 and input to the main processor 1902. The main processor 1902 will then process the received signal for output to the display 1910 or alternatively to the auxiliary I/O subsystem 1912. A subscriber may also compose data items, such as e-mail messages, for example, using the keyboard 1916 in conjunction with the display 1910 and possibly the auxiliary I/O subsystem 1912. The auxiliary subsystem 1912 may include devices such as: a touch screen, mouse, track ball, infrared fingerprint detector, or a roller wheel with dynamic button pressing capability. The keyboard 1916 is preferably an alphanumeric keyboard and/or telephone-type keypad. However, other types of keyboards may also be used. A composed item may be transmitted over the wireless network 1905 through the communication subsystem 1904.

For voice communications, the overall operation of the fusion reactor control mobile device 1900 is substantially similar, except that the received signals are output to the speaker 1918, and signals for transmission are generated by the microphone 1920. Alternative voice or audio I/O subsystems, such as a voice message recording subsystem, can also be implemented on the fusion reactor control mobile device 1900. Although voice or audio signal output is accomplished primarily through the speaker 1918, the display 1910 can also be used to provide additional information such as the identity of a calling party, duration of a voice call, or other voice call related information.

In some implementations, the fusion reactor control mobile device 1900 includes a camera 1950 receiving a plurality of images 1954 from and examining pixel-values of the plurality of images 1954.

### CONCLUSION

A rifled toroidal pinch fueled by a mixture of helium3 and deuterium is described. A technical effect of the rifled toroidal pinch fueled by a mixture of helium3 and deuterium is shaping electromagnetic force and generating maximum compression force onto a plasma in an experimental nuclear fusion reactor. Although specific implementations are illustrated and described herein, it will be appreciated by those of ordinary skill in the art that any arrangement which is calculated to achieve the same purpose may be substituted for the specific implementations shown. This application is intended to cover any adaptations or variations.

In particular, one of skill in the art will readily appreciate that the names of the methods and apparatus are not intended to limit implementations. Furthermore, additional methods and apparatus can be added to the components, functions can be rearranged among the components, and new components to correspond to future enhancements and physical devices used in implementations can be introduced without departing from the scope of implementations. One of skill in the art will readily recognize that implementations are applicable to future, different and new fusion confinement devices 110, first half-shells 114, second half-shells 116, inner chambers 118, flanges 120 and 122, insulation layers 124, non-ferrous and non-conductive fasteners 126 and 128, terminals 130, terminals 132, vacuum pumps 134, vacuum lines 136, vacuum ports 138, fuel injectors 140, fuel lines 142, fuel tanks 144, gas injectors 146, gas line 148, gas tank 150, EM foils 152, gas sensors 154, electric lines 156, electrical sources 158, pre-ionizers 160, electric lines 162, electrical sources 164, electrical switches 166, electric lines 168 and 170, conductive center pieces 172, electrical sources 174 and electrical sinks 176.

The terminology used in this application is meant to include all environments and alternate technologies which provide the same functionality as described herein.

In some implementations, a fusion system includes a first half-shell enclosing a first hemisphere of a hollow toroidal interior chamber; a second half-shell enclosing a second hemisphere of the hollow toroidal interior chamber, the first hemisphere and the second hemispheres forming two hemispheres; wherein the first hemisphere of the hollow toroidal interior chamber and the second hemisphere of the hollow toroidal interior chamber form the hollow toroidal interior chamber; wherein the hollow toroidal interior chamber includes an interior surface having rifling; wherein the first half-shell and the second half-shell both have a diameter of at least 1 meter and no more than 3 meters; wherein the first half-shell and the second half-shell are fastened together; wherein the first half-shell and the second half-shell are made of non-ferrous materials, wherein the non-ferrous material comprise an aluminum/scandium alloy with no more than 1% scandium; a first flange on an outer perimeter of the first half-shell and that extends away from a center axis of the fusion system; a second flange on the outer perimeter of the second half-shell and that extends away from the center axis of the fusion system; an insulator that is positioned between the first flange of the first half-shell and the second half-shell of the second half-shell; a conductive center piece that is between an inner perimeter of the first half-shell and the inner perimeter of the second half-shell, but is absent between the center axis and the hemispheres of the first half-shell and the second half-shell, putting the first half-shell in electrical contact with the second half-shell; wherein the fusion system does not include electromagnetic coils; wherein the fusion system is not a Z-pinch device, a sheet-pinch device, a screw pinch device, a reversed field pinch device, a toroidal pinch device, an inverse pinch device, a cylinder pinch device, an orthogonal pinch device, a Ware pinch device, a MagLIF pinch device or an uncontrolled pinch device; wherein the hollow toroidal interior chamber includes a one-turn EM foil; further comprising an electronic controller that generates a plurality of pulses of electrical energy; a first electrical line electrically coupled to the first half-shell; a second electrical line electrically coupled to the second half-shell; an electrical source electrically coupled to first electrical lines; an electrical sink electrically coupled to the second electrical line, wherein the electrical sink includes an electrical conditioner electrically coupled to an electrical power distribution grid; a gas injector mounted in either the first hemisphere of the hollow toroidal interior chamber or the second hemisphere of the hollow toroidal interior chamber, that receives a gas from outside the hollow toroidal interior chamber and injects the gas into the hollow toroidal interior chamber; wherein the gas is argon, helium or air; a fuel injector mounted in either the first hemisphere of the hollow toroidal interior chamber or the second hemisphere of the hollow toroidal interior chamber, that receives a fuel from outside the hollow toroidal interior chamber and injects the fuel into the hollow toroidal interior chamber; wherein the fuel is a mixture of a helium3 and a deuterium, wherein the mixture of the helium3 and the deuterium is approximately equal amounts of the helium3 and the deuterium, wherein the mixture of the helium3 and the deuterium is lean in deuterium in order to reduce fusion between atoms of the deuterium that produce harmful protons; a gas sensor mounted in either the first hemisphere of the hollow toroidal interior chamber or the second hemisphere of the hollow toroidal interior chamber, that determines a composition of the gas and a pressure of the gas inside the hollow toroidal interior chamber and transmits the composition and the pressure of the gas in the hollow toroidal interior chamber; and a controller that is electrically coupled to the electrical source, the gas injector, a vacuum pump, a vacuum port, an electrical switch, the gas sensor, a pre-ionizer and the fuel injector that generates and transmits commands to the gas injector to achieve and maintain a predetermined composition of the gas and predetermined pressure of the gas, and that determines a pattern of the plurality of pulses of the electrical energy from the electrical source to a first electrical conductor and that transmits the pattern of plurality of pulses of the electrical energy, wherein each of the plurality of pulses of the electrical energy is about a square wave, having a duration of 1 millisecond and having a pulse strength of approximately 0.5 megagausses.

In some implementations, a fusion system includes a fusion confinement device enclosing a hollow toroidal interior chamber that includes an interior surface having rifling; and a fuel injector mounted in the fusion confinement device that receives a fuel wherein the fuel is a mixture of a helium3 and a deuterium, wherein the mixture of the helium3 and the deuterium is approximately equal amounts of the helium3 and the deuterium.

In some implementations, a fusion system includes a housing enclosing a hollow toroidal interior chamber, wherein the hollow toroidal interior chamber includes an interior surface having a rifling.

1. An experimental fusion system comprising:
a first shell that includes a first hemisphere of a toroidal interior chamber;
a second shell includes a second hemisphere of the toroidal interior chamber;
wherein the first hemisphere of the toroidal interior chamber and the second hemisphere of the toroidal interior chamber form all of the toroidal interior chamber;
wherein the toroidal interior chamber includes an interior surface having rifling;
wherein the first shell and the second shell both have a diameter of at least 1 meter and no more than 3 meters;
wherein the first shell and the second shell are fastened together;
wherein the first shell and the second shell are made of non-ferrous material, wherein the non-ferrous material comprise an aluminum/scandium alloy allow with no more than 1% scandium;
a first flange on the outer perimeter of the first shell and that extends away from a center axis of the experimental fusion system; and
a conductive center piece is a ring and is positioned between the inside perimeter of the first shell and the inside perimeter of the second shell, but is absent between the center axis and the hemispheres of the first shell and the second shell, putting the first shell in electrical contact with the second shell.

2. The experimental fusion system of claim 1, further comprising:
a coil in the toroidal interior chamber, the coil being operably coupled to the first shell and the second shell;
a first electrical line electrically coupled to the first shell;
an electronic controller electrically coupled to the first electrical line that generates a plurality of pulses of electrical energy;
a second electrical line electrically coupled to the second shell;
an electrical source electrically coupled to the first electrical line;
an electrical sink electrically coupled to the second electrical line, wherein the electrical sink includes an electrical conditioner electrically coupled to an electrical power distribution grid;
a gas injector mounted in either the first hemisphere of the toroidal interior chamber or the second hemisphere of the toroidal interior chamber, that receives a gas from outside the toroidal interior chamber and injects the gas into the toroidal interior chamber; wherein the gas is argon, helium or air;
a fuel injector mounted in either the first hemisphere of the toroidal interior chamber or the second hemisphere of the toroidal interior chamber, that receives a fuel from outside the toroidal interior chamber and injects the fuel into the toroidal interior chamber;
a gas sensor mounted in either the first hemisphere of the toroidal interior chamber or the second hemisphere of the toroidal interior chamber, that determines a composition of the gas and a pressure of the gas inside the toroidal interior chamber and transmits the composition and the pressure of the gas in the toroidal interior chamber; and
a controller that is electrically coupled to the electrical source, the gas injector, vacuum pump, s vacuum port, an electric power switch, the gas sensor, a pre-ionizer and the fuel injector that generates and transmits commands to the gas injector to achieve and maintain a predetermined composition of the gas and predetermined pressure of the gas, and that determines a pattern of the plurality of pulses of the electrical energy from the electrical source to a first electrical conductor and that transmits the pattern of plurality of pulses of the electrical energy, wherein each of the plurality of pulses of the electrical energy is about a square wave, having a duration of 1 millisecond and having a pulse strength of approximately 0.5 megagausses,
wherein the experimental fusion system produces an aneutronic fusion reaction, thus no excessive quantities of heat from a fusion reaction and the experimental fusion system does not include a steam turbine to generate electricity;
wherein the experimental fusion system does not include electromagnetic coils; and
wherein the experimental fusion system is not a Z-pinch device, a sheet-pinch device, a screw pinch device, a reversed field pinch device, a toroidal pinch device, an inverse pinch device, a cylinder pinch device, an orthogonal pinch device, a Ware pinch device, a MagLIF pinch device or an uncontrolled pinch device.

3. The experimental fusion system of claim 2 wherein the fuel is a mixture of helium3 and deuterium is approximately equal amounts of the helium3 and the deuterium.

4. The experimental fusion system of claim 2 wherein the fuel is a mixture of helium3 and deuterium that is lean in deuterium in order to reduce fusion between atoms of the deuterium that produce harmful protons.

5. The experimental fusion system of claim 2 wherein the fuel is a mixture of p-Boron 11 hydride, a helium, a deuterium and a hydrogen.

6. The experimental fusion system of claim 2 wherein the fuel is 100% deuterium.

7. The experimental fusion system of claim 1
a second flange on the outer perimeter of the second shell and that extends away from the center axis of the experimental fusion system.

8. The experimental fusion system of claim 7
an insulator that is positioned between the first flange of the first shell and the second shell of the second shell.
